(19) United States
(12) Patent Application Publication
(10) Pub. No.: US 2015/0325163 A1
(43) Pub. Date: Nov. 12, 2015

(54) IMAGE DISPLAY DEVICE AND DRIVING METHOD THEREFOR

(71) Applicant: Sharp Kabushiki Kaisha, Osaka-shi, Osaka (JP)

(72) Inventor: Masamitsu KOBAYASHI, Osaka (JP)

(21) Appl. No.: 14/410,533

(22) PCT Filed: Jul. 17, 2013
(86) PCT No.: PCT/JP2013/069356

§ 371 Date: Dec. 22, 2014

(30) Foreign Application Priority Data
Jul. 24, 2012 (JP) 2012-163601
Oct. 5, 2012 (JP) 2012-222923

(51) Int. Cl. G09G 3/20; G09G 3/36; G02F 1/1334; G09G 3/34

(52) U.S. Cl. CPC G09G 3/2022; G09G 3/3413; G09G 3/2059; G09G 3/3648; G02F 1/1334; G09G 2320/0238; G09G 2360/16

(57) ABSTRACT

Provided is an image display device capable of causing a background to be seen through and realizing black display while alleviating restriction on the installation position of a light source unit. The image display device includes a CF-less liquid crystal panel, a PDLC panel, and a first PDLC light source unit. The PDLC panel is located on the rear surface of the CF-less liquid crystal panel. At the time of image display, the PDLC panel is in a diffusion state. At this time, light-source light of the first PDLC light source unit is diffused by the PDLC panel and is emitted to the CF-less liquid crystal panel, and background light is diffused by the PDLC panel. At the time of image non-display, the PDLC panel is in a transmission state. At this time, the background light is transmitted through the PDLC panel and arrives at the CF-less liquid crystal panel.

### TECHNICAL FIELD

The present invention relates to an image display device, and particularly to an image display device capable of causing a background to be seen through and a driving method therefor.

### BACKGROUND ART

In recent years, image display apparatuses capable of performing image display and causing backgrounds to be seen through have been developed. For example, Japanese Unexamined Patent Application Publication No. 5-191726 discloses a realistic-display apparatus that performs display in which an image is combined with a background. FIG. 38 is a diagram illustrating the configuration of a realistic-display apparatus 200 disclosed in Japanese Unexamined Patent Application Publication No. 5-191726. As illustrated in FIG. 38, the realistic-display apparatus 200 includes a projector 201, a transmittance control screen 202, an image extraction device 203, and an image contour forming device 204. The image extraction device 203 extracts an image to be displayed. The projector 201 projects the extracted image to the transmittance control screen 202. The image contour forming device 204 extracts contour information regarding the image to be displayed and controls the state of the transmittance control screen 202 based on the contour information. The transmittance control screen 202 is specifically a polymer dispersed liquid crystal (PDLC) panel. The transmittance control screen 202 is controlled such that only regions to which projection light from the projector 201 is radiated are in a state in which light is diffused (hereinafter referred to as a “diffusion state”) and the other regions are in a state in which light is transmitted (hereinafter referred to as a “transmission state”). Thus, the realistic-display apparatus 200 can perform display, in which the above-described image to be displayed is combined with a background including, for example, an ornamental tree 206 and a wall picture 207, for an observer 205.

### CITATION LIST

### Patent Literature

PTL 1: Japanese Unexamined Patent Application Publication No. 5-191726

PTL 2: Japanese Unexamined Patent Application Publication No. 2008-34372

PTL 3: Japanese Unexamined Patent Application Publication No. 2006-106614

### SUMMARY OF INVENTION

### Technical Problem

The PDLC panel can diffuse or transmit light, but may not shield light. Accordingly, black display may not be performed in the realistic-display apparatus 200 using only the PDLC panel as a panel (screen) contributing to the image display. In the realistic-display apparatus 200, the projector 201 not only functions as a light source unit but also forms an image. Accordingly, in the realistic-display apparatus 200, a position at which the projector 201 is installed is restricted to a relatively narrow range so as to appropriately set a focal distance or the like of light radiated from the projector 201.

Accordingly, an object of the present invention is to provide an image display device capable of causing a background to be seen through and realizing black display while alleviating restriction on a position at which a light source unit is installed, and a driving method therefor.

### Solution to Problem

According to a first aspect of the invention, there is provided an image display device that displays an image by dividing one frame period of a supplied input signal into a plurality of sub-frame periods and switching a display color for each sub-frame period. The image display device includes: a first display panel that includes a plurality of first display elements disposed in a matrix form; and a light radiation unit that is able to radiate light of a plurality of colors to the first display panel. The light radiation unit includes a light source unit and a second display panel which is able to switch between a diffusion state in which incident light is diffused and a transmission state in which incident light is transmitted. The second display panel is in the diffusion state and diffuses light emitted by the light source unit when the image is displayed. The first display panel displays the image by controlling transmittance of the light diffused by the second display panel.

According to a second aspect of the invention, in the first aspect, the light source unit may further include a first light source unit for the second display panel. The first light source unit for the second display panel includes light-emitting elements of the plurality of colors and radiates light to the second display panel.

According to a third aspect of the invention, in the second aspect, the first light source unit for the second display panel may radiate light to one main surface of the second display panel.

According to a fourth aspect of the invention, in the third aspect, the light source unit may further include a second light source unit for the second display panel. The second light source unit for the second display panel includes light-emitting elements of the plurality of colors and radiates light to the second display panel. The first light source unit for the second display panel and the second light source unit for the second display panel may radiate light to both main surfaces of the second display panel, respectively.

According to a fifth aspect of the invention, in the second aspect, the first light source unit for the second display panel may have enough directivity to radiate light to a part of the second display panel.

According to a sixth aspect of the invention, in any one of the first to fifth aspects, the light radiation unit may further include a first light guide plate guiding incident light, and the light source unit may include a light source unit for a light guide plate. The light source unit for a light guide plate includes light-emitting elements of the plurality of colors and radiating light to the first light guide plate.

According to a seventh aspect of the invention, in the sixth aspect, the first light guide plate and the second display panel may be disposed in order on a side of the first display panel.

According to an eighth aspect of the invention, in the sixth aspect, the second display panel and the first light guide plate may be disposed in order on a side of the first display panel.

According to a ninth aspect of the invention, in the sixth aspect, the light radiation unit may further include a second light guide plate guiding incident light, the light source unit for the light guide plate may radiate light to the first light guide plate and the second light guide plate, and the first light guide plate, the second display panel, and the second light guide plate may be disposed in order on a side of the first display panel.

According to a tenth aspect of the invention, in the sixth aspect, the first light guide plate may be configured to be formed by a plurality of blocks, and the light source unit for the light guide plate may radiate light to each block.

According to an eleventh aspect of the invention, in the first aspect, the second display panel may include a plurality of second display elements each of which is switchable between the diffusion state and the transmission state.

According to a twelfth aspect of the invention, in the eleventh aspect, when the image is displayed, each of the second display elements in correspondence to one of the plurality of first display elements may be in the diffusion state in synchronization with the corresponding first display element.

According to a thirteenth aspect of the invention, in the first aspect, the image display device may further include: a first display driving unit that drives the first display panel; a second display driving unit that drives the second display panel; a light source driving unit that drives the light source unit; and a signal processing unit that controls each of the first display driving unit, the second display driving unit, and the light source driving unit based on the input signal.

According to a fourteenth aspect of the invention, in the thirteenth aspect, the signal processing unit may include a field sequential processing unit that generates field sequential image data for displaying an image for each sub-frame period based on the input signal, an image control unit that generates first display data for controlling the first display driving unit, second display data for controlling the second display driving unit, and light source data for controlling the light source driving unit, based on display image position designation data for designating a display position of the image to be displayed and the field sequential image data, which are obtained based on the input signal, a first display control unit that controls the first display driving unit based on the first display data, a second display control unit that controls the second display driving unit based on the second display data, and a light source control unit that controls the light source driving unit based on the light source data.

According to a fifteenth aspect of the invention, in the fourteenth aspect, the input signal may include the display image position designation data and image data indicating the image to be displayed, and the signal processing unit may further include a signal separation control unit that separates the input signal into the display image position designation data and the image data and supplies the display image position designation data and the image data to the image control unit and the field sequential processing unit, respectively.

According to a sixteenth aspect of the invention, in the fourteenth aspect, the field sequential processing unit may further generate the display image position designation data based on the input signal.

According to a seventeenth aspect of the invention, in the thirteenth aspect, the signal processing unit may interpolate an image to be displayed for each of continuous frame periods using the sub-frame period.

According to an eighteenth aspect of the invention, in the thirteenth aspect, the first display panel may include a display area for displaying the image of a desired color when color data is supplied for each sub-frame period, and the signal processing unit may generate the color data based on the input signal for each sub-frame period, obtain a light source light-up time designating a light-up time of the light-emitting element of a color indicated by the color data and a light source driving timing control signal for controlling at least one of a light-up start time of the light-emitting element of the color and a scanning start time at which the color data is supplied to the display area, and control the light source light-up time and the light source driving timing control signal in correspondence to a period in which the color data necessary to display the image of the desired color is supplied to the display area.

According to a nineteenth aspect of the invention, in the eighteenth aspect, the first display panel may further include a non-display area in which color data is supplied for each sub-frame period and the image is not displayed, and the color data supplied to the non-display area may be same color data for each pixel of the non-display area.

According to a twentieth aspect of the invention, in the nineteenth aspect, the signal processing unit may include a field sequential processing unit that generates field sequential image data for displaying an image for each sub-frame period based on the input signal, an image control unit that generates first display data for controlling the first display driving unit, second display data for controlling the second display driving unit, and light source data for controlling the light source driving unit and including the light-source light-up time, based on display image position designation data for designating a display position of the image to be displayed and the field sequential image data, which are obtained based on the input signal, a first display control unit that controls the first display driving unit based on the first display data, a second display control unit that controls the second display driving unit based on the second display data, and a light source control unit that controls the light source driving unit based on the light source driving timing control signal and the light source data.

According to a twenty first aspect of the invention, there is provided a driving method for an image display device that includes a first display panel including a plurality of first display elements disposed in a matrix form and a light radiation unit able to radiate light of a plurality of colors to the first display panel and including a second display panel, and that displays an image by dividing one frame period of a supplied input signal into a plurality of sub-frame periods and switching a display color for each sub-frame period. The driving method includes: a step of switching a state of the second display panel between a diffusion state in which incident light is diffused and a transmission state in which incident light is transmitted; and a step of causing the first display panel to control transmittance of light diffused by the second display panel and to display the image. The light radiation unit further includes a light source unit. The step of switching the state of the second display panel includes a step of switching the state of the second display panel to the diffusion state when the image is displayed and diffusing light emitted by the light source unit.

### Advantageous Effects of Invention

According to the first aspect of the invention, in the image display device of the field sequential (hereinafter appropriately abbreviated as “FS”) scheme, the image display is performed by diffusing light emitted by the light source unit by the second display panel being in the diffusion state and controlling the transmittance of the diffused light by the first display panel. Therefore, the black display can be performed by shielding the diffused light by the first display panel. Since an image to be displayed is formed by the first display panel rather than the light source unit, it is possible to alleviate the restriction on the installation position of the light source unit (a projector in Japanese Unexamined Patent Application Publication No. 5-191726). When the second display panel is in the transmission state, the background light can be transmitted. By adopting the FS scheme, it is possible to perform color image display with high resolution and high light use efficiency.

According to the second aspect of the invention, the image display can be performed by radiating light from the first light source unit for the second display panel to the second display panel and controlling the transmittance of the diffused light by the first display panel.

According to the third aspect of the invention, by radiating light to one main surface of the second display panel, it is possible to obtain the same advantageous effect as that of the second aspect of the invention.

According to the fourth aspect of the invention, since light is radiated to both main surfaces of the second display panel, it is possible to improve the luminance of the display image.

According to the fifth aspect of the invention, it is possible to allow light to be radiated to the spot to be in the diffusion state and allow light not to be radiated to the spot to be in the transmission state in the second display panel. Therefore, the spot in which the image display is performed and the spot in which the background is seen through can be allowed to appropriately coexist in one screen.

According to the sixth aspect of the invention, the image display is performed by radiating light emitted by the light source unit for the light guide plate to the second display panel via the first light guide plate and controlling the transmittance of the diffused light by the first display panel. When the first light source unit for the second display panel, the light source unit for the light guide plate, and the first light guide plate are used, it is possible to improve the luminance of the display image. When the first and second light source units for the second display panel, the light source unit for the light guide plate, and the first light guide plate are used, it is possible to further improve the luminance of the display image.

According to the seventh aspect of the invention, by disposing the first light guide plate and the second display panel in order on the side of the first display panel, it is possible to obtain the same advantageous effect as that of the sixth aspect of the invention.

According to the eighth aspect of the invention, by disposing the second display panel and the first light guide plate in order on the side of the first display panel, it is possible to obtain the same advantageous effect as that of the sixth aspect of the invention.

According to the ninth aspect of the invention, by disposing the first light guide plate, the second display panel, and the second light guide plate in order, it is possible to obtain the same advantageous effect as that of the sixth aspect of the invention. Since light emitted from each of the first and second light guide plates is diffused by the second display panel and is radiated to the first display panel, it is possible to improve the luminance of the display image.

According to the tenth aspect of the invention, since the first light guide plate formed by the blocks is used, it is possible to allow light to be radiated to the spot to be in the diffusion state and to allow light not to be radiated to the spot to be in the transmission state in the second display panel. Therefore, the spot in which the image display is performed and the spot in which the background is seen through can be allowed to appropriately coexist in one screen.

According to the eleventh aspect of the invention, the second display panel includes the plurality of second display elements and each second display element can be switched between the diffusion state and the transmission state. Therefore, the spot to be in the diffusion state and the spot to be in the transmission state can be set in the second display panel to be suitable for the display position of the image. Thus, it is possible to simultaneously perform the image display and the background transmission.

According to the twelfth aspect of the invention, since the second display element is set to the diffusion state in synchronization with the first display element, the spot to be in the diffusion state and the spot to be in the transmission state in the second display panel are set to follow the image displayed on the first display panel. Therefore, in moving-image display or the like, the diffused light from the second display panel is reliably radiated to the first display panel. Thus, it is possible to improve image quality, for example, when the moving image is displayed.

According to the thirteenth aspect of the invention, by using the signal processing unit, the first display driving unit, the second display driving unit, and the light source driving unit controlled by the signal processing unit, it is possible to reliably drive the first display panel, the second display panel, and the light source unit.

According to the fourteenth aspect of the invention, by using the signal processing unit including the FS processing unit, the image control unit, the first display control unit, the second display control unit, and the light source control unit, it is possible to reliably perform driving of the FS scheme.

According to the fifteenth aspect of the invention, since the display image position designation data is included in the input signal, it is possible to reliably reflect a display position of the image intended in a generation source of the input signal.

According to the sixteenth aspect of the invention, since the display image position designation data is generated by the FS processing unit, it is possible to set the display position of the image in real time, for example, or set the display position of the image to a position determined in advance.

According to the seventeenth aspect of the invention, since the frame interpolation is performed using the sub-frame period, smooth display of a moving image can be performed.

According to the eighteenth aspect of the invention, the light source light-up time and the light source driving timing control signal are controlled in correspondence to a period in which the color data necessary to display an image of a desired color is supplied to the display area. Therefore, the display area in which the image of the desired color is displayed and occurrence of color irregularity is suppressed can be set to a desired position of the first display panel.

According to the nineteenth aspect of the invention, the color data supplied to the non-display area is the same data for each color and for each pixel of the non-display area. Therefore, the non-display area becomes an area in which occurrence of the color irregularity is suppressed.

According to the twentieth aspect of the invention, by using the signal processing unit including the FS processing unit, the image control unit, the first display control unit, the second display control unit, and the light source control unit, it is possible to reliably perform the driving of the FS scheme.

According to the twenty first aspect of the invention, in the driving method for the image display device, it is possible to obtain the same advantageous effects as those of the first aspect of the invention.

### BRIEF DESCRIPTION OF DRAWINGS

FIG. 1 is a block diagram illustrating the configuration of an image display device according to a first embodiment of the invention.

FIG. 2 is a diagram illustrating the configuration of a CF-less liquid crystal panel illustrated in FIG. 1.

FIG. 3 is a diagram illustrating the configuration of a PDLC panel illustrated in FIG. 1.

FIG. 4 is a diagram illustrating the configuration of a first PDLC light source unit illustrated in FIG. 1.

FIG. 5 is a block diagram illustrating the configuration of a signal processing circuit illustrated in FIG. 1.

FIG. 6 is a block diagram illustrating the configuration of an image control unit illustrated in FIG. 5.

FIG. 7 is a perspective view for describing disposition of the CF-less liquid crystal panel, the PDLC panel, and the first PDLC light source unit according to the first embodiment.

FIG. 8 is a sectional view corresponding to one pixel of the CF-less liquid crystal panel and the PDLC panel illustrated in FIG. 7.

FIG. 9 is a diagram for describing an operation when a red image is displayed according to the first embodiment. Section A shows a timing at which red data is supplied to the CF-less liquid crystal panel, Section B shows a timing at which white data is supplied to the PDLC panel, and Section C shows a light-up start time and a light-up time at which a light-emitting element of each color lights up.

FIG. 10 is a diagram for describing superposition of the CF-less liquid crystal panel and the PDLC panel.

FIG. 11 is a diagram for describing an operation during each sub-frame period according to the first embodiment. Section A shows frame images, Section B shows sub-frame images, and Section C shows diffusion state spots.

FIG. 12 is a block diagram illustrating the configuration of a signal processing circuit according to a first modification example of the first embodiment.

FIG. 13 is a diagram for describing an operation during each sub-frame period according to a second modification example of the first embodiment. Section A shows frame images, Section B shows sub-frame images, and Section C shows diffusion state spots.

FIG. 14 is a sectional view corresponding to one pixel of the CF-less liquid crystal panel and the PDLC panel according to a third modification example of the first embodiment.

FIG. 15 is a perspective view for describing disposition of the CF-less liquid crystal panel, the PDLC panel, and first and second PDLC light source units according to a fourth modification example of the first embodiment.

FIG. 16 is a sectional view corresponding to one pixel of the CF-less liquid crystal panel and the PDLC panel illustrated in FIG. 15.

FIG. 17 is a diagram illustrating the configuration of a backlight unit including a general light guide plate.

FIG. 18 is a diagram illustrating the configuration of a backlight unit according to a second embodiment of the invention.

FIG. 19 is a perspective view for describing disposition of a CF-less liquid crystal panel, a PDLC panel, and a first light guide plate according to the second embodiment.

FIG. 20 is a sectional view corresponding to one pixel of the CF-less liquid crystal panel, the PDLC panel, and the first light guide plate illustrated in FIG. 19.

FIG. 21 is a perspective view for describing disposition of the CF-less liquid crystal panel, the PDLC panel, and the first light guide plate according to a first modification example of the second embodiment.

FIG. 22 is a sectional view corresponding to one pixel of the CF-less liquid crystal panel, the PDLC panel, and the first light guide plate illustrated in FIG. 21.

FIG. 23 is a perspective view for describing disposition of the CF-less liquid crystal panel, the PDLC panel, and first and second light guide plates according to a second modification example of the second embodiment.

FIG. 24 is a sectional view corresponding to one pixel of the CF-less liquid crystal panel, the PDLC panel, and the first and second light guide plates illustrated in FIG. 23.

FIG. 25 is a perspective view for describing disposition of the CF-less liquid crystal panel, the PDLC panel, the PDLC light source unit, and the first light guide plate according to a third embodiment of the invention.

FIG. 26 is a sectional view corresponding to one pixel of the CF-less liquid crystal panel, the PDLC panel, and the first light guide plate illustrated in FIG. 25.

FIG. 27 is a perspective view for describing disposition of the CF-less liquid crystal panel, the PDLC panel, the PDLC light source unit, and the first light guide plate according to a first modification example of the third embodiment.

FIG. 28 is a sectional view corresponding to one pixel of the CF-less liquid crystal panel, the PDLC panel, and the first light guide plate illustrated in FIG. 27.

FIG. 29 is a perspective view for describing disposition of the CF-less liquid crystal panel, the PDLC panel, the PDLC light source unit, and first and second light guide plates according to a second modification example of the third embodiment.

FIG. 30 is a sectional view corresponding to one pixel of the CF-less liquid crystal panel, the PDLC panel, and the first and second light guide plates illustrated in FIG. 29.

FIG. 31 is a diagram for describing color irregularity. Section A shows a timing at which red data is supplied to the CF-less liquid crystal panel and Section B shows a light-up start time and a light-up time at which a light-emitting element of each color lights up.

FIG. 32 is a block diagram illustrating the configuration of a signal processing circuit according to a fourth embodiment of the invention.

FIG. 33 is a block diagram illustrating the configuration of an image control unit illustrated in FIG. 32.

FIG. 34 is a diagram for describing an operation when a red image is displayed in a display area according to the fourth embodiment. Section A shows a timing at which red data is supplied to the CF-less liquid crystal panel and Section B shows a light-up start time and a light-up time at which a light-emitting element of each color lights up.

FIG. 35 is a diagram for describing an operation when a red image is displayed in display areas according to a first modification example of the fourth embodiment. Section A shows a timing at which red data is supplied to the CF-less liquid crystal panel and Section B shows a light-up start time and a light-up time at which a light-emitting element of each color lights up.

FIG. 36 is a diagram for describing an operation when a red image is displayed in a display area according to a second modification example of the fourth embodiment. Section A shows a timing at which red data is supplied to the CF-less liquid crystal panel and Section B shows a light-up start time and a light-up time at which a light-emitting element of each color lights up.

FIG. 37 is a diagram for describing an operation when a red image is displayed in a display area according to a third modification example of the fourth embodiment. Section A shows a timing at which red data is supplied to the CF-less liquid crystal panel and Section B shows a light-up start time and a light-up time at which a light-emitting element of each color lights up.

FIG. 38 is a diagram illustrating the configuration of a realistic-display apparatus disclosed in Japanese Unexamined Patent Application Publication No. 5-191726.

### DESCRIPTION OF EMBODIMENTS

Hereinafter, first to fourth embodiments of the invention will be described with reference to the appended drawings.

### 1. First Embodiment

### 1.1 Overall Configuration

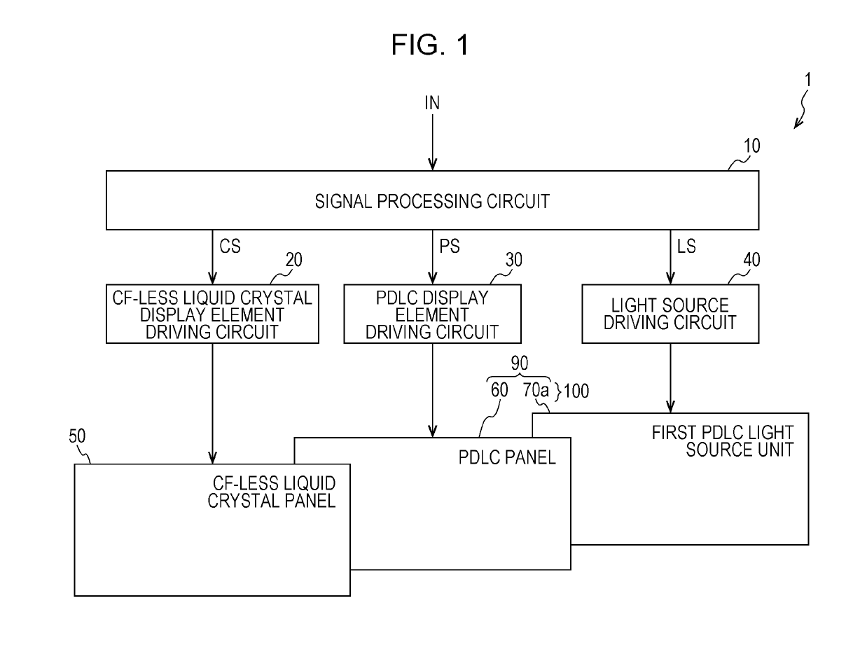

FIG. 1 is a block diagram illustrating the configuration of an image display device 1 according to a first embodiment of the invention. In the following description, a color filter is abbreviated as a “CF.” The image display device 1 includes a signal processing circuit 10, a CF-less liquid crystal display element driving circuit 20, a PDLC display element driving circuit 30, a light source driving circuit 40, a CF-less liquid crystal panel 50, a PDLC panel 60, and a first PDLC light source unit 70a. In the embodiment, the CF-less liquid crystal display element driving circuit 20 corresponds to a first display driving unit, the PDLC display element driving circuit 30 corresponds to a second display driving unit, the CF-less liquid crystal panel 50 corresponds to a first display panel, the PDLC panel 60 corresponds to a second display panel, and the first PDLC light source unit 70a corresponds to first and second light source units for a display panel. In the embodiment, the PDLC panel 60 and the first PDLC light source unit 70a form a light radiation unit 90. In the embodiment, the first PDLC light source unit 70a forms a light source unit 100.

The image display device 1 displays an image on the CF-less liquid crystal panel 50 in conformity to a field sequential scheme (FS scheme). In conformity to the FS scheme, light-emitting elements such as light emitting diodes (LEDs) or cathode fluorescent lamps (CCFLs) of red (R), green (G), and blue (B) which form backlight light are switched sequentially. In the FS scheme, a transmission state is controlled by sequentially supplying color data corresponding to the colors of light of the light-emitting elements to a liquid crystal panel in synchronization with the sequential switching of the light-emitting elements, so that additive color mixing is performed for retinae of an observer. According to the FS scheme, since color display can be performed without forming a plurality of sub-pixels in one pixel, a high resolution can be realized. Since light from the light-emitting elements can be used without change, it is unnecessary to form the CF in each pixel (that is, a CF-less configuration is realized), and thus light use efficiency of each light-emitting element is improved.

The signal processing circuit 10 receives an input signal IN from the outside and controls the CF-less liquid crystal display element driving circuit 20, the PDLC display element driving circuit 30, and the light source driving circuit 40 based on the input signal IN. More specifically, the signal processing circuit 10 supplies a CF-less liquid crystal display element signal CS for controlling the CF-less liquid crystal display element driving circuit 20 to the CF-less liquid crystal display element driving circuit 20, supplies a PDLC display element signal PS for controlling the PDLC display element driving circuit 30 to the PDLC display element driving circuit 30, and supplies a light source signal LS for controlling the light source driving circuit 40 to the light source driving circuit 40.

The CF-less liquid crystal display element driving circuit 20 drives the CF-less liquid crystal panel 50 based on the received CF-less liquid crystal display element signal CS. The PDLC display element driving circuit 30 drives the PDLC panel 60 based on the received PDLC display element signal PS. The light source driving circuit 40 drives the first PDLC light source unit 70a based on the received light source signal LS.

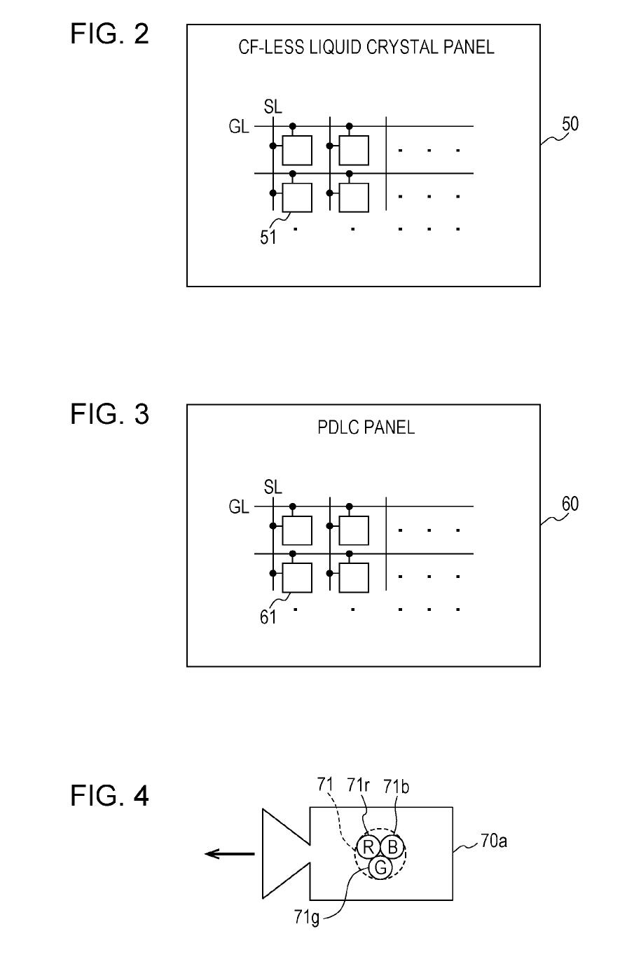

FIG. 2 is a diagram illustrating the configuration of the CF-less liquid crystal panel 50 illustrated in FIG. 1. The CF-less liquid crystal panel 50 includes a plurality of signal lines SL, a plurality of scanning lines GL, and a plurality of CF-less liquid crystal display elements 51 disposed in a matrix form in correspondence to intersections between the plurality of signal lines SL and the plurality of scanning lines GL. The CF-less liquid crystal panel 50 is driven by the CF-less liquid crystal display element driving circuit 20 so that transmittance of each CF-less liquid crystal display element 51 is controlled. In the embodiment, black display can be realized by controlling the transmittance of the CF-less liquid crystal display elements 51. The CF-less liquid crystal panel 50 in the embodiment may be of any one of a normally black type and a normally white type. In the embodiment, the CF-less liquid crystal display element 51 corresponds to a first display element.

FIG. 3 is a diagram illustrating the configuration of the PDLC panel 60 illustrated in FIG. 1. The PDLC panel 60 includes a plurality of signal lines SL, a plurality of scanning lines GL, and a plurality of PDLC display elements 61 disposed in a matrix form in correspondence to intersections between the plurality of signal lines SL and the plurality of scanning lines GL. Each PDLC display element 61 corresponds to one of the plurality of CF-less liquid crystal display elements 51. The number of PDLC display elements 61 (the number of pixels of the PDLC panel 60) may not necessarily be identical to the number of CF-less liquid crystal display elements 51 (the number of pixels of the CF-less liquid crystal panel 50). The PDLC panel 60 includes a PDLC layer. For example, when no voltage is applied, the PDLC layer is in a diffusion state in which incident light is diffused. When a voltage is applied, the PDLC layer is in a transmission state in which incident light is transmitted. Alternatively, when no voltage is applied, the PDLC layer may be in the transmission state. When a voltage is applied, the PDLC layer may be in the diffusion state. The state of the PDLC layer can be controlled in units of the PDLC display elements 61. In the present specification, to facilitate the description, the state of the PDLC layer is described as the state of the PDLC panel 60 or the state of the PDLC display element 61 in some cases. The PDLC panel 60 is driven by the PDLC display element driving circuit 30 so that the state of each PDLC display element 61 is controlled. In the embodiment, the PDLC display element 61 corresponds to a second display element.

The PDLC panel 60 may be configured to be switchable to an intermediate state in which incident light is diffused and transmitted in addition to the diffusion state and the transmission state. In other words, the PDLC panel 60 may be configured to be switched between the diffusion state in which diffusivity is relatively high, the transmission state in which diffusivity is relatively low, and the intermediate state in which diffusivity is a value between the value at the time of the diffusion state and the value at the time of the transmission state. Here, the “diffusivity” in the present specification refers to a value indicating how much incident light is diffused. The larger the value of the diffusivity is, the larger the degree of diffusion is. The diffusivity of the PDLC panel 60 is controlled with an application voltage. For example, the larger the application voltage is, the smaller the diffusivity is. The larger the diffusivity of the PDLC panel 60 is, the larger the application voltage is. A plurality of kinds of intermediate states may be set. Use of the intermediate state of the PDLC panel 60 will be described below.

FIG. 4 is a diagram illustrating the configuration of the first PDLC light source unit 70a illustrated in FIG. 1. The first PDLC light source unit 70a includes a plurality of light sources 71 which each include one red light-emitting element 71r, one green light-emitting element 71g, and one blue light-emitting element 71b. The disposition of the plurality of light sources 71 is not particularly limited. Each light-emitting element is an LED, a CCFL, a laser light source, an inorganic or organic electro-luminescence (EL) light source, or the like. As in a projector, the first PDLC light source unit 70a may have a configuration in which a device such as a DMD or an LCOS, a lens, a color wheel, and the like may be added to various light-emitting elements. The first PDLC light source unit 70a preferably has enough directivity to radiate light to a part of the PDLC panel 60, but may not have such directivity. Each light source 71 is configured such that a light intensity can be controlled for each color. For example, the light-up state and the light-off state of each light source 71 are configured to be controlled for each color. The first PDLC light source unit 70a emits red light, green light, and blue light (hereinafter the red light, the green light, and the blue light are collectively referred to as “light-source light” in some cases) by sequentially lighting up the red light-emitting element 71r, the green light-emitting element 71g, and the blue light-emitting element 71b. However, the light-up order of the light-emitting elements of the respective colors is not particularly limited. For example, the red light-emitting element 71r, the green light-emitting element 71g, the green light-emitting element 71g, and the blue light-emitting element 71b may be configured to sequentially light up.

Here, the light source 71 is not limited to the case in which one red light-emitting element 71r, one green light-emitting element 71g, and one blue light-emitting element 71b are included. For example, the light source 71 may include two red light-emitting elements 71r, two green light-emitting elements 71g, and one blue light-emitting element 71b in some cases. Alternatively, the light source 71 may include one red light-emitting element 71r, two green light-emitting elements 71g, and one blue light-emitting element 71b in some cases. The number of light sources 71 is not limited to the plurality. The number of light sources 71 may be one. The color of light emitted by one white LED may be switched using fluorescents or CFs emitting red, green, and blue light.

The CF-less liquid crystal panel 50 displays an image by controlling the transmittance of light radiated from the light radiation unit 90 formed by the PDLC panel 60 and the first PDLC light source unit 70a. The radiation of light toward the CF-less liquid crystal panel 50 will be described in detail below.

### 1.2 Signal Processing Circuit

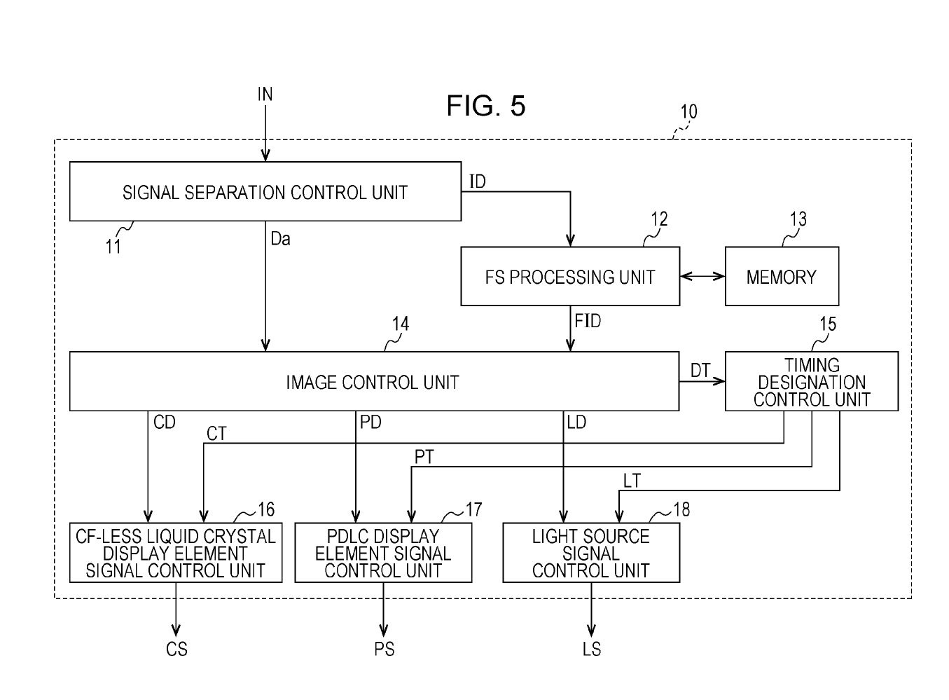

FIG. 5 is a block diagram illustrating the configuration of the signal processing circuit 10 illustrated in FIG. 1. The signal processing circuit 10 includes a signal separation control unit 11, a field sequential processing unit (FS processing unit) 12, a memory 13, an image control unit 14, a timing designation control unit 15, a CF-less liquid crystal display element signal control unit 16, a PDLC display element signal control unit 17, and a light source signal control unit 18.

In the embodiment, an input signal IN includes display image position designation data Da designating the display position of an image to be displayed and image data ID indicating the image to be displayed. The signal separation control unit 11 receives the input signal IN and separates the input signal IN into the display image position designation data Da and the image data ID. The signal separation control unit 11 supplies the display image position designation data Da to the image control unit 14 and supplies the image data ID to the FS processing unit 12.

The FS processing unit 12 generates a field sequential image data (FS image data) FID for displaying an image for each sub-frame period based on the received image data ID and supplies the generated FS image data FID to the image control unit 14. More specifically, for example, when the FS processing unit 12 receives the image data ID with a frame rate of 60 fps, the FS processing unit 12 converts the image data ID into image data ID with a frame rate of 240 fps (performs frame rate conversion). Then, based on the image data ID with the frame rate of 240 fps, the FS processing unit 12 generates red, green, and blue FS image data FID of a frame rate of 240 fps. Hereinafter, an image indicated by the image data ID is referred to as a “frame image” and an image indicated by the FS image data FID is referred to as a “sub-frame image” in some cases. The frame rate after the above-described frame rate conversion is not limited to 240 fps. When a response speed of each display element can be handled, the frame rate is preferably higher.

When the FS processing unit 12 generates the FS image data FID, the FS processing unit 12 uses information retained by the memory 13. The information retained by the memory 13 specifically indicates a focal distance of the first PDLC light source unit 70a (the light source unit 100) and the diffusivity of each PDLC display element 61. Thus, the FS image data FID includes data according to the number of divisions of an area (hereinafter referred to as a “division area”) in which the state of the PDLC panel 60 is independently controlled, and expansion of light from each division area, and the like. Hereinafter, an area of the CF-less liquid crystal panel 50 corresponding to (more specifically facing) the division area of the PDLC panel 60 is also referred to as a “division area” in some cases. A register which sets information regarding a focal distance of the first PDLC light source unit 70a (the light source unit 100), a diffused amount of light radiated to each PDLC display element 61, and the like may be installed instead of the memory 13 or along with the memory 13.

Based on the display image position designation data Da and the FS image data FID, the image control unit 14 generates CF-less liquid crystal data CD for controlling the CF-less liquid crystal display element signal control unit 16, PDLC data PD for controlling the PDLC display element signal control unit 17, light source data LD for controlling the light source signal control unit 18, and a driving timing control signal DT for adjusting timings by synchronizing output signals of the CF-less liquid crystal display element signal control unit 16, the PDLC display element signal control unit 17, and the light source signal control unit 18. In other words, the driving timing control signal DT is a signal controlling an operation start time of each panel or unit (hereinafter referred to as “each module”) of the CF-less liquid crystal panel 50, the PDLC panel 60, and the first PDLC light source unit 70a to synchronize the CF-less liquid crystal panel 50, the PDLC panel 60, and the first PDLC light source unit 70a. The image control unit 14 supplies the driving timing control signal DT, the CF-less liquid crystal data CD, the PDLC data PD, and the light source data LD to the timing designation control unit 15, the CF-less liquid crystal display element signal control unit 16, the PDLC display element signal control unit 17, and the light source signal control unit 18, respectively. The detailed configuration of the image control unit 14 will be described below.

The timing designation control unit 15 receives the driving timing control signal DT generated by the image control unit 14 and generates a CF-less liquid crystal timing designation signal CT designating a driving timing of each CF-less liquid crystal display element 51, a PDLC timing designation signal PT designating a driving timing of each PDLC display element 61, and a light source timing designation signal LT designating a driving timing of each light source 71 based on the driving timing control signal DT. The timing designation control unit 15 can use the memory 13 or the register (not illustrated) installed outside the timing designation control unit 15, for example, when the timing designation control unit 15 generates the CF-less liquid crystal timing designation signal CT, the PDLC timing designation signal PT, and the light source timing designation signal LT. The timing designation control unit 15 supplies the generated CF-less liquid crystal timing designation signal CT, PDLC timing designation signal PT, and light source timing designation signal LT to the CF-less liquid crystal display element signal control unit 16, the PDLC display element signal control unit 17, and the light source signal control unit 18, respectively.

The CF-less liquid crystal display element signal control unit 16 generates a CF-less liquid crystal display element signal CS based on the received CF-less liquid crystal data CD and CF-less liquid timing designation signal CT and supplies the CF-less liquid crystal display element signal CS to the CF-less liquid crystal display element driving circuit 20.

The PDLC display element signal control unit 17 generates a PDLC display element signal PS based on the received PDLC data PD and PDLC timing designation signal PT and supplies the PDLC display element signal PS to the PDLC display element driving circuit 30.

The light source signal control unit 18 generates a light source signal LS based on the received light source data LD and light source timing designation signal LT and supplies the light source signal LS to the light source driving circuit 40.

### 1.3 Image Control Unit

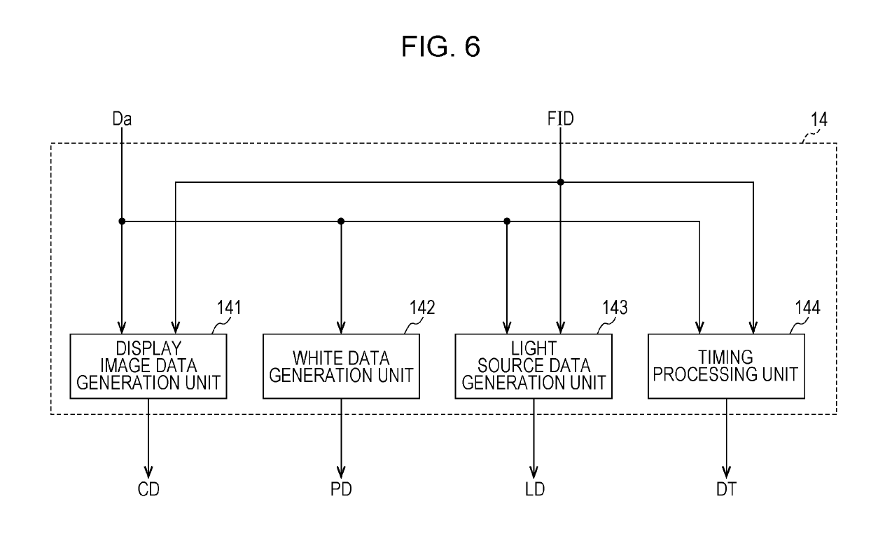

FIG. 6 is a block diagram illustrating the configuration of the image control unit 14 illustrated in FIG. 5. The image control unit 14 includes a display image data generation unit 141, a white data generation unit 142, a light source data generation unit 143, and a timing processing unit 144.

The display image data generation unit 141 receives the display image position designation data Da and the FS image data FID and generates the CF-less liquid crystal data CD as display image data corresponding to a display image based on the display image position designation data Da and the FS image data FID. The CF-less liquid crystal display element signal control unit 16 can set transmittance of each CF-less liquid crystal display element 51 in the CF-less liquid crystal panel 50 based on the CF-less liquid crystal data CD.

The white data generation unit 142 receives the display image position designation data Da and generates the PDLC data PD as white data for causing a part or the entirety of the PDLC panel 60 to be white (diffusion state) based on the display image position designation data Da. Based on the PDLC data PD, the PDLC display element signal control unit 17 can set the state of the PDLC panel 60 according to the position of the display image. More specifically, the PDLC panel 60 is in the diffusion state at a position corresponding to the display image. However, the state of the entire PDLC panel 60 may be set uniformly. In this case, it is unnecessary to supply the display image position designation data Da to the white data generation unit 142 and it is unnecessary to supply the PDLC timing designation signal PT to the PDLC display element signal control unit 17.

The light source data generation unit 143 receives the display image position designation data Da and the FS image data FID and generates the light source data LD based on the display image position designation data Da and the FS image data FID. The light source signal control unit 18 can set a light-up time or the like of the light-emitting element of each color based on the light source data LD. When the first PDLC light source unit 70a has enough directivity to radiate light to a part of the PDLC panel 60, the light source signal control unit 18 controls the light source driving circuit 40 such that the first PDLC light source unit 70a individually radiate light-source light to each division area of the PCLC panel 60. The light source signal control unit 18 may designate the light-emitting elements to light up according to the position of the display image based on the light source data LD. When the light source signal control unit 18 may not necessarily designate the light-emitting elements to light up according the position of the display image, the light source data generation unit 143 may not be supplied with the display image position designation data Da.

The timing processing unit 144 receives the display image position designation data Da and the FS image data FID and generates the driving timing control signal DT based on the display image position designation data Da and the FS image data FID. More specifically, the timing processing unit 144 generates the driving timing control signal DT based on a desired relation which is a relation between scanning driving start times of the CF-less liquid crystal panel 50 and the PDLC panel 60 and the light-up start time of the light-emitting elements and which can be obtained from the display image position designation data Da and the FS image data FID.

### 1.4 Disposition of Panel and Light Source Unit

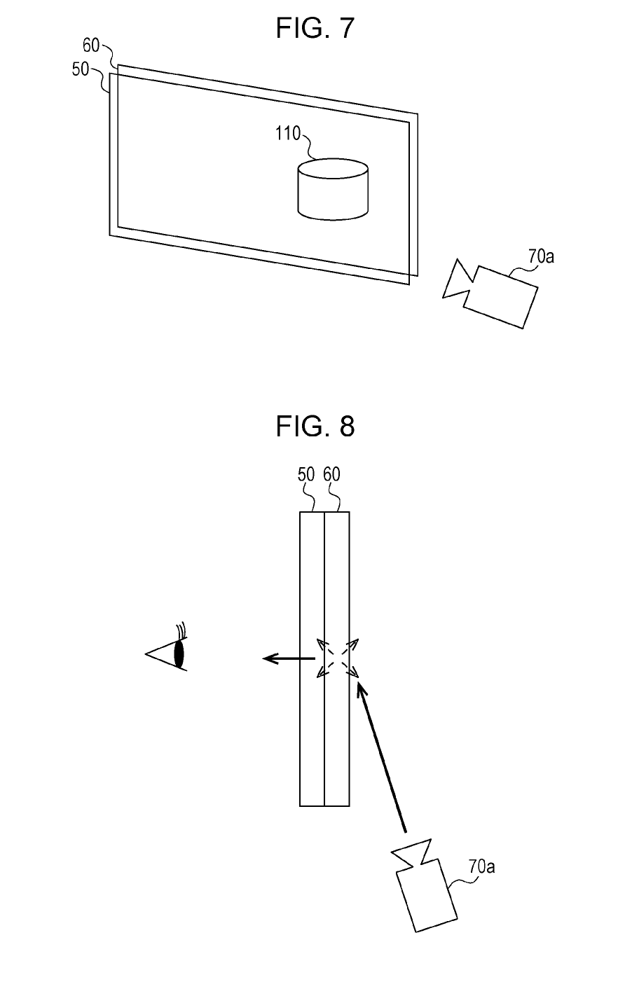

FIG. 7 is a perspective view for describing disposition of the CF-less liquid crystal panel 50, the PDLC panel 60, and the first PDLC light source unit 70a according to the first embodiment. Here, the front side of the sheet surface of FIG. 7 is referred to as a front surface (which is a surface on the location side of an observer) and the opposite side is referred to as a rear surface (the same applies to perspective views to be described below). As illustrated in FIG. 7, the PDLC panel 60 is located on the rear surface of the CF-less liquid crystal panel 50. Specifically, the CF-less liquid crystal display element 51 corresponding to the above-described PDLC display element 61 is the CF-less liquid crystal display element 51 facing this PDLC display element 61. The first PDLC light source unit 70a may be located on any of the upper end side (sheet surface upper side), the lower end side (sheet surface lower side), the left end side (sheet surface left side), and the right end side (sheet surface right side) of the CF-less liquid crystal panel 50 and the PDLC panel 60 or may be located on a plurality of the end sides or all of the end sides. As illustrated in FIG. 7, for example, an exhibition object 110 is assumed to be disposed on the rear surface side of the PDLC panel 60. However, note that the disposing of the exhibition object 110 in this way is not indispensable.

FIG. 8 is a sectional view corresponding to one pixel of the CF-less liquid crystal panel 50 and the PDLC panel 60 illustrated in FIG. 7. One pixel mentioned herein is one pixel with reference to the CF-less liquid crystal panel 50 (the CF-less liquid crystal display elements 51). As described above, the number of pixels of the CF-less liquid crystal panel 50 may not necessarily be identical to the number of pixels of the PDLC panel 60. An air layer or the like may be installed between the CF-less liquid crystal panel 50 and the PDLC panel 60. In FIG. 8, the sheet surface left side is referred to as a front surface and the sheet surface right side is referred to as a rear surface (the same applies to sectional views to be described below). In the following description, one pixel illustrated in FIG. 8 is referred to as a “pixel of interest” in some cases to facilitate the description. The first PDLC light source unit 70a in the embodiment radiates light-source light to the rear surface (one main surface) of the PDLC panel 60.

First, a case (the time of image display) in which the pixels of interest form an image will be described. In this case, no voltage is applied to the PDLC display elements 61 and the PDLC display elements 61 are in the diffusion state. At this time, the first PDLC light source unit 70a radiates the light-source light to a division area (hereinafter referred to as a “division area of interest”: a division area of the CF-less liquid crystal panel 50 including the pixel of interest is also likewise referred to as a “division area of interest”) of the PDLC panel 60 including the pixel of interest. Therefore, the light-source light incident on the PDLC display elements 61 is diffused and a substantially vertical component (hereinafter referred to as a “front-surface-direction vertical component”) oriented toward the CF-less liquid crystal display elements 51 in the diffused light-source light is emitted to the CF-less liquid crystal display elements 51. Further, light from the rear surface of the PDLC display elements 61 (the image display device 1), i.e., light (hereinafter referred to as “background light”) indicating a background including the exhibition object 110, is also incident on the PDLC display elements 61. As described above, since the PDLC display elements 61 are in the diffusion state, the background light incident on the PDLC display elements 61 is diffused and the front-surface-direction vertical component of the diffused background light is emitted to the CF-less liquid crystal display elements 51.

In this way, at the time of the image display, the light radiation unit 90 formed by the PDLC panel 60 and the first PDLC light source unit 70a radiates the diffused light-source light and light formed by the front-surface-direction vertical component of the background light to the CF-less liquid crystal panel 50 (the CF-less liquid crystal display elements 51). Since the PDLC panel 60 diffuses the background light at the time of the image display, the background light arriving at the CF-less liquid crystal panel 50 has only the front-surface-direction vertical component after the diffusion. Therefore, an influence of the background light on the display image is sufficiently suppressed.

Next, a case (the time of non-image display) in which the pixels of interest do not form an image will be described. Here, when no image is displayed, there are two kinds of cases, i.e., a case (hereinafter referred to as “the time of entire surface non-display”) in which no image is displayed on the entire surface of the CF-less liquid crystal panel 50 and a case (hereinafter referred to as “the time of partial non-display”) in which the pixel of interest does not form an image, but a pixel forming an image is present besides. Of the time of the entire surface non-display and the time of the partial non-display, the time of entire surface non-display will be first described. In the embodiment, in a portion in which no image is displayed, relatively high transmittance is assumed to be set in the CF-less liquid crystal display elements 51 in order that the background can be seen through. When the background may not necessarily be seen through, the transmittance of the CF-less liquid crystal display elements 51 may also be set to a relatively low value (that is, black display) in the portion in which no image is displayed. In the portion in which no image is displayed, the PDLC display elements 61 may be in the diffusion state or the intermediate state. In this way, it is possible to adjust the degree of the background to be seen through. For example, the background may be slightly seen through. Even in a portion in which an image is displayed, the background may be seen through slightly within a range in which image quality does not deteriorate by setting the PDLC display elements 61 such that the PDLC display elements 61 be in the intermediate state. Thus, when the intermediate state of the PDLC display element 61 (the PDLC panel 60) is used, various kinds of display can be realized.

At the time of entire surface non-display, a voltage is applied to the PDLC display elements 61, and thus these PDLC display elements 61 be in the transmission state. The light-source light is not emitted from the first PDLC light source unit 70a to any division area of the PDLC panel 60. Therefore, only the background light transmitted through the PDLC display elements 61 is radiated to the CF-less liquid crystal display elements 51. In this way, the background is seen through.

At the time of the partial non-display, the PDLC display elements 61 be in the transmission state as in the time of entire surface non-display. Unlike the time of entire surface non-display, on the other hand, the light-source light is not emitted to the division area of interest from the first PDLC light source unit 70a and the light-source light is emitted from the first PDLC light source unit 70a to the other division areas. Thus, the background light transmitted through the PDLC display elements 61 is radiated to the CF-less liquid crystal display elements 51 of the division area in which no image display is performed, and the diffused light-source light and light with the front-surface-direction vertical component are emitted to the CF-less liquid crystal display elements 51 of the division area in which the image display is performed. Therefore, it is possible to simultaneously perform the image display and the background transmission, and a spot in which the image display is performed and a spot in which the background transmission is performed can be allowed to appropriately coexist in one screen. However, when the first PDLC light source unit 70a does not have enough directivity to radiate light to a part of the PDLC panel 60, the light-source light is not radiated for each division area. For example, the light-source light is radiated to the entire surface of the PDLC panel 60.

### 1.5 Operation

Next, an operation of displaying a color image in the embodiment will be described. Hereinafter, a case in which a read image is mainly displayed in driving of an FS scheme (hereinafter referred to as “FS driving”) of sequentially displaying red, green, and blue images will be exemplified. However, the invention is not limited thereto. In the FS driving, images with any color of a plurality of colors may be displayed sequentially, for example, images of red, green, green, and blue colors may be displayed sequentially. The invention is applied even to a case in which images with any two colors or all colors among three red, green, and blue colors are displayed. The invention is also likewise applied not only to the FS driving of displaying red, green, and blue images in order and displaying color images but also to other FS driving such as FS driving of sequentially displaying, for example, cyan (C), magenta (M), and yellow (Y) images or FS driving in which color states coexist in a screen in combination with local dimming driving.

When full-color display is not necessary, images may be displayed in the order of white, white, white, and white colors, the order of red, red, red, and red colors, or the like. In this case, the light sources 71 may not necessarily have a plurality of colors. In this case, one frame period may not necessarily be divided into a plurality of sub-frame periods. In such a configuration, it is possible to improve power efficiency of the first PDLC light source unit 70a.

Here, the “red image” in the present specification will be defined. The “red image” refers to a red image with the maximum luminance. In the FS driving in which one frame is formed by three red, green, and blue sub-frames, an image when data with the maximum transmission amount of red light is supplied as red data and data with the minimum transmission amount of green and blue light is supplied as the blue and green data to the CF-less liquid crystal panel 50 is referred to as the “red image.” Hereinafter, data with the maximum transmission amount of each color light is referred to as “transmission data” and data with the minimum transmission amount of each color light is referred to as “shielding data.”

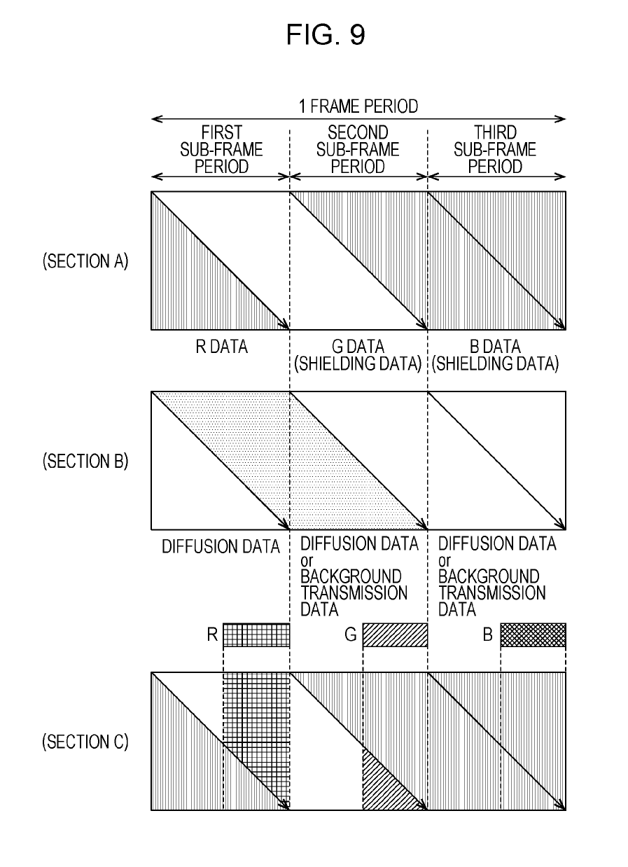

FIG. 9 is a diagram for describing an operation when a red image is displayed according to the embodiment. More specifically, Section A of FIG. 9 shows a timing at which red data is supplied to the CF-less liquid crystal panel 50, Section B of FIG. 9 shows a timing at which white data is supplied to the PDLC panel 60, and Section C of FIG. 9 shows a light-up start time and a light-up time at which a light-emitting element of each color lights up. Here, there are two kinds of white data to be supplied to the PDLC panel 60. One kind of white data is diffusion data causing the PDLC panel 60 to be in the diffusion state and the other kind of white data is background transmission data causing the PDLC panel 60 to be in the transmission state.

For a first sub-frame period, as shown in Section A of FIG. 9, scanning driving of the CF-less liquid crystal panel 50 is performed from the upper end of a screen to the lower end thereof from a start time of the first sub-frame period, and thus transmission data is sequentially supplied as red data to each pixel. As shown in Section B of FIG. 9, scanning driving of the PDLC panel 60 is performed from the upper end of the screen to the lower end thereof from the start time of the first sub-frame period in synchronization with the CF-less liquid crystal panel 50, and thus diffusion data is sequentially supplied as white data to each pixel. As shown in Section C of FIG. 9, the red light-emitting element 71r lights up when a predetermined time (for example, a half period of the first sub-frame period) has passed from the start time of the first sub-frame period, and then lights off at an end time of the first sub-frame period.

For a second sub-frame period, as shown in Section A of FIG. 9, the scanning driving of the CF-less liquid crystal panel 50 is performed from the upper end of the screen to the lower end thereof from a start time of the second sub-frame period, and thus shielding data is sequentially supplied as green data to each pixel. As shown in Section B of FIG. 9, scanning driving of the PDLC panel 60 is performed from the upper end of the screen to the lower end thereof from the start time of the second sub-frame period in synchronization with the CF-less liquid crystal panel 50, and thus diffusion data is sequentially supplied as white data to each pixel. As shown in Section C of FIG. 9, the green light-emitting element 71g lights up when a predetermined period (for example, a half period of the second sub-frame period) has passed from the start time of the second sub-frame period, and then lights off at an end time of the second sub-frame period.

For a third sub-frame period, as shown in Section A of FIG. 9, the scanning driving of the CF-less liquid crystal panel 50 is performed from the upper end of the screen to the lower end thereof from a start time of the third sub-frame period, and thus shielding data is sequentially supplied as blue data to each pixel. As shown in Section B of FIG. 9, scanning driving of the PDLC panel 60 is performed from the upper end of the screen to the lower end thereof from the start time of the third sub-frame period in synchronization with the CF-less liquid crystal panel 50, and thus diffusion data is sequentially supplied as white data to each pixel. As shown in Section C of FIG. 9, the blue light-emitting element 71b lights up when a predetermined period (for example, a half period of the third sub-frame period) has passed from the start time of the third sub-frame period, and then lights off at an end time of the third sub-frame period.

In this way, the red image is displayed on the screen. The timing of each scanning driving and the light-up timing of each light-emitting element indicated herein are not particularly limited. As shown in section C of FIG. 9, the green color is slightly mixed in the lower part (lower half) of the screen, and thus color irregularity occurs. However, no problem is assumed to occur particularly herein. When the red image is displayed on the entire screen, as shown in Section A, Section B, and Section C of FIG. 9, the background transmission data may be supplied to the PDLC panel 60 instead of the diffusion data for the second and third sub-frame periods. The diffusion data may be constantly supplied to the PDLC panel 60 for each sub-frame period without the synchronization of the scanning driving of the PDLC panel 60 through the scanning driving of the CF-less liquid crystal panel 50.

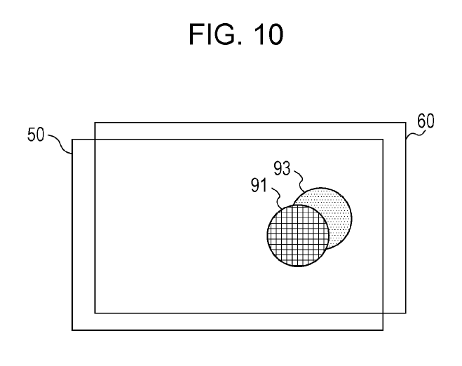

FIG. 10 is a diagram for describing superposition of the CF-less liquid crystal panel 50 and the PDLC panel 60. When the number of pixels of the PDLC panel 60 is set to be equal to or greater than the number of pixels of the CF-less liquid crystal panel 50, as illustrated in FIG. 10, a spot (hereinafter referred to as a “diffusion state spot 93”) which is in the diffusion state in the PDLC panel 60 can be set to be suitable with an image display spot 91 in the CF-less liquid crystal panel 50. In this case, the background can be seen through at spots other than the image display spot 91 of the screen. When the number of pixels of the PDLC panel 60 is less than the number of pixels of the CF-less liquid crystal panel 50 but the number of pixels of the PDLC panel 60 is plural, the background can be seen through in a part of the screen. The pixels of the PDLC panel 60 may not necessarily be disposed in the matrix form. By setting the disposition of the pixels of the PDLC panel 60 according to the shape of an image to be displayed on the CF-less liquid crystal panel 50, various states (the diffusion state, the transmission state, and the intermediate state) of the PDLC panel 60 can be applied to the image display more appropriately even when the number of pixels of the PDLC panel 60 is less than the number of pixels of the CF-less liquid crystal panel 50. The number of pixels of the PDLC panel 60 may be one, and the diffusion state and the transmission state may be switched on the entire PDLC panel 60.

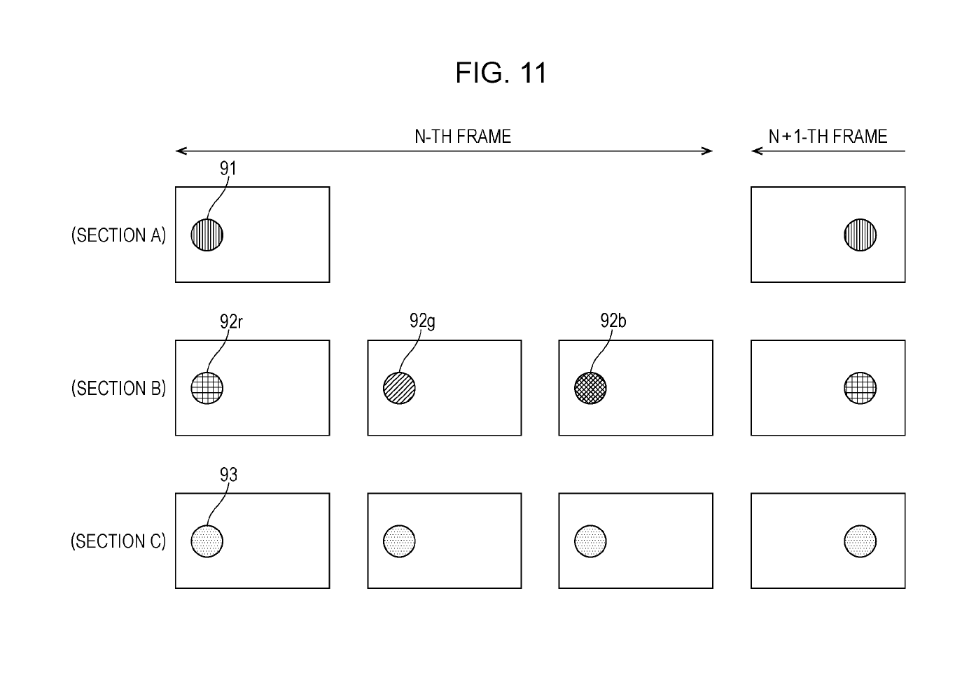

FIG. 11 is a diagram for describing an operation during each sub-frame period according to the embodiment. More specifically, Section A of FIG. 11 shows frame images, Section B of FIG. 11 shows sub-frame images, and Section C of FIG. 11 shows diffusion state spots. As shown in Section A, Section B, and Section C of FIG. 11, display spots 92r, 92g, and 92b of the sub-frame images of an N-th frame (where N is a natural number) are located at the same position as the image display spot 91 of the frame image and the diffusion state spots 93 are set to be suitable for the display spots 92r, 92g, and 92b. The same applies to an N+1-th frame.

### 1.6 Advantageous Effect

According to the embodiment, in the image display device 1 of the FS scheme, the image display is performed by diffusing the light-source light emitted from the light source unit 100 (first PDLC light source unit 70a) by the PDLC panel 60 in the diffusion state and controlling the transmittance of the diffused light (more specifically, the front-surface-direction vertical component of the diffused light) by the CF-less liquid crystal panel 50. Therefore, by shielding the diffused light by the CF-less liquid crystal panel 50, it is possible to realize the black display. Since an image to be displayed is formed by the CF-less liquid crystal panel 50 rather than the light source unit 100, it is possible to alleviate the restriction on the installation position of the light source unit 100. When the PDLC panel 60 is in the transmission state, the background light can be transmitted. By adopting the FS scheme, it is possible to perform color image display with high resolution and high use efficiency of light.

According to the embodiment, the PDLC panel 60 includes the plurality of PDLC display elements 61 and each PDLC display element 61 can be switched between the diffusion state and the transmission state. Therefore, in the PDLC panel 60, the spot to be in the diffusion state and the spot to be in the diffusion state can be set to be suitable for the display position of the image. Thus, it is possible to simultaneously perform the image display and the background transmission.

According to the embodiment, the light-source light can be radiated to the spot to be in the diffusion state in the PDLC panel 60 and the light-source light may not be radiated to the spot to be in the transmission state. Therefore, the spot in which the image display is performed and the spot in which the background transmission is performed can be allowed to appropriately coexist in one screen.

According to the embodiment, since the PDLC display element 61 is set to the diffusion state in synchronization with the CF-less liquid crystal display element 51, the spot to be in the diffusion state and the spot to be in the transmission state in the PDLC panel 60 are set to follow the image displayed on the CF-less liquid crystal panel 50. Therefore, for example, in display of a moving image, the diffused light from the PDLC panel 60 is reliably radiated to the CF-less liquid crystal panel 50. Thus, it is possible to improve image quality at the time of display of a moving image.

According to the embodiment, by using the intermediate state of the PDLC display element 61 (the PDLC panel 60), it is possible to perform various kinds of display.

According to the embodiment, by using the signal processing circuit 10 including the FS processing unit 12, the image control unit 14, the CF-less liquid crystal display element signal control unit 16, the PDLC display element signal control unit 17, and the light source signal control unit 18, it is possible to reliably perform the FS driving.

According to the embodiment, since the display image position designation data Da is included in the input signal IN, the intended display position of the image can be reliably reflected in the generation source of the input signal IN.

According to the embodiment, by using the CF-less liquid crystal timing designation signal CT, the PDLC timing designation signal PT, and the light source timing designation signal LT generated based on the driving timing control signal DT, it is possible to reliably control the driving of each CF-less liquid crystal display element 51, each PDLC display element 61, and each light source 71. By separating the timing designation control unit 15 from the image control unit 14 and using the memory 13, the register, or the like, it is easy to individually adjust an operation start time of each module, as necessary.

According to the embodiment, by radiating the light-source light to the rear surface of the PDLC panel 60, the light-source light of the first PDLC light source unit 70a is efficiently used when a diffusion effect in a transmission direction (which refers to a direction in which the incident light is transmitted) of the PDLC panel 60 is higher than a diffusion effect in a reflection direction (which refers to a direction in which the incident light is reflected). More specifically, the front-surface-direction vertical component of the diffused light-source light increases. Therefore, it is possible to improve the luminance of the display image.

According to the embodiment, as described above, when the first PDLC light source unit 70a has enough directivity to radiate light to a part of the PDLC panel 60, the first PDLC light source unit 70a can radiate the light-source light to each division area. Therefore, it is possible to perform so-called area active-driving (also called local dimming driving) of adjusting light intensity of the light-source light for each division area. Through such area active-driving, as in the FS driving, it is possible to suppress so-called color breakup which easily occurs when a screen of another color component is switched at a high speed. Since the light-source light can be emitted from the first PDLC light source unit 70a in accordance with the scanning directions of the CF-less liquid crystal panel 50 and the PDLC panel 60, it is possible to suppress the above-described color irregularity further than when the light-source light is uniformly emitted to the entire surface of the PDLC panel 60. At this time, the scanning of the light-source light may not necessarily be tuned in accordance with the scanning direction of the PDLC panel 60. By tuning the scanning of the light-source light in accordance with the scanning direction of the CF-less liquid crystal panel 50, it is possible to suppress the foregoing color irregularity.

In the above description, the mode in which the light-up state and the light-off state are controlled for each color has been exemplified as the example in which each light source 71 controls light intensity for each color, but the invention is not limited thereto. For example, each light source 71 may control the light-up state and the light-off state for each color and control light intensity of the light-up state for each color. Thus, it is possible to adjust white balance in a portion in which the image is displayed. Further, it is possible to lessen (or zero) light intensity of a color unnecessary in the image.

### 1.7 First Modification Example

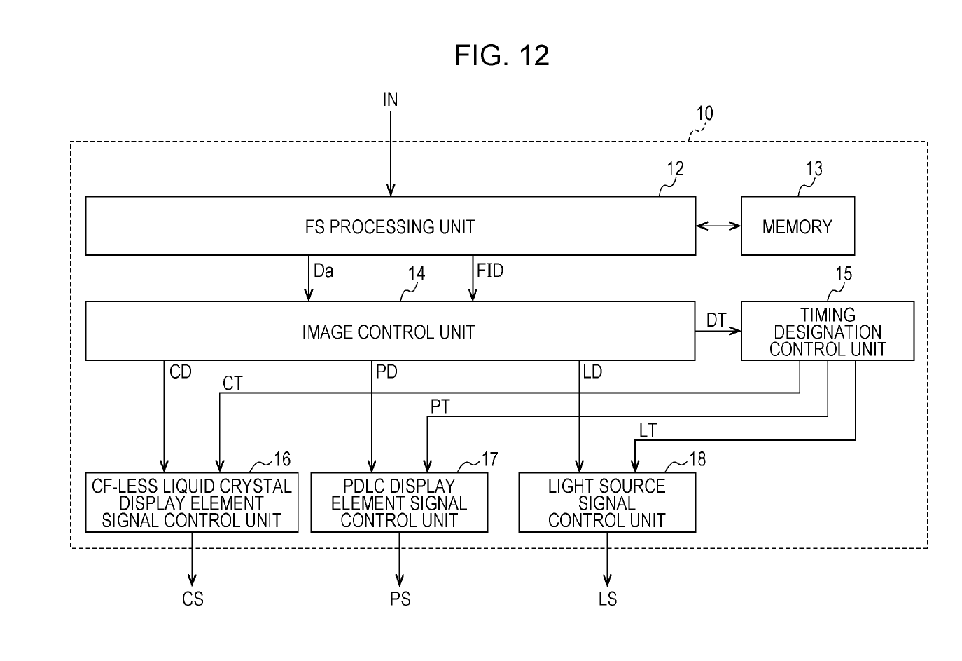

FIG. 12 is a block diagram illustrating the configuration of the signal processing circuit 10 according to a first modification example of the first embodiment. In the modification example, the signal processing circuit 10 does not include the signal separation control unit 11 unlike the signal processing circuit 10 according to the foregoing first embodiment. In the modification example, the FS processing unit 12 generates the display image position designation data Da and the FS image data FID based on the input signal IN and supplies the display image position designation data Da and the FS image data FID to the image control unit 14. In the modification example, the input signal IN includes the image data ID.

The FS processing unit 12 can simultaneously perform, for example, a process (generating the FS image data FID or the like) of performing the FS driving and a process (hereinafter referred to as a “first process”) of determining the display position of an image in real time through a frame interpolation process or the like and designating a position on the screen at which the background light is not allowed to be transmitted. For example, the FS processing unit 12 can simultaneously perform the process of performing the FS driving and a process (hereinafter referred to as a “second process”) of setting the display position of an image using the memory 13, the register (not illustrated), or the like installed outside the FS processing unit 12 and designating a position in the screen at which the background light is not allowed to be transmitted. In this case, the memory 13 retains information regarding the display position of the image.

An example of the first process is a process of determining that a given pixel (hereinafter referred to as a “corresponding pixel”) is a non-display position of the image when data (that is, data desired to be transmitted or of which color display is not necessary) of which three primary color signal values included in the input signal IN (image data ID) are mutually identical is output and the data in a constant range of the corresponding pixel is the data of which three primary color signal values are mutually identical as in the corresponding pixel. In the first process, the display position of the image can be set in real time without including the display image position designation data Da in the input signal IN and the state of each PDLC display element 61 can be set according to the display position. When data of which the three primary color signal values included in the input signal IN are mutually similar is output and each piece of data in the constant range of the corresponding pixel is data of which the three primary color signal values are mutually similar as in the corresponding pixel, the corresponding pixel may be determined to be located at the non-display position of the image.

As the foregoing second process, for example, by designating a predetermined region in the screen as a region in which the background is not allowed to be seen through, the image can be displayed in the predetermined region which is determined in advance and the state of each PDLC display element 61 can be set according to the position of the predetermined region without including the display image position designation data Da in the input signal IN.

### 1.8 Second Modification Example

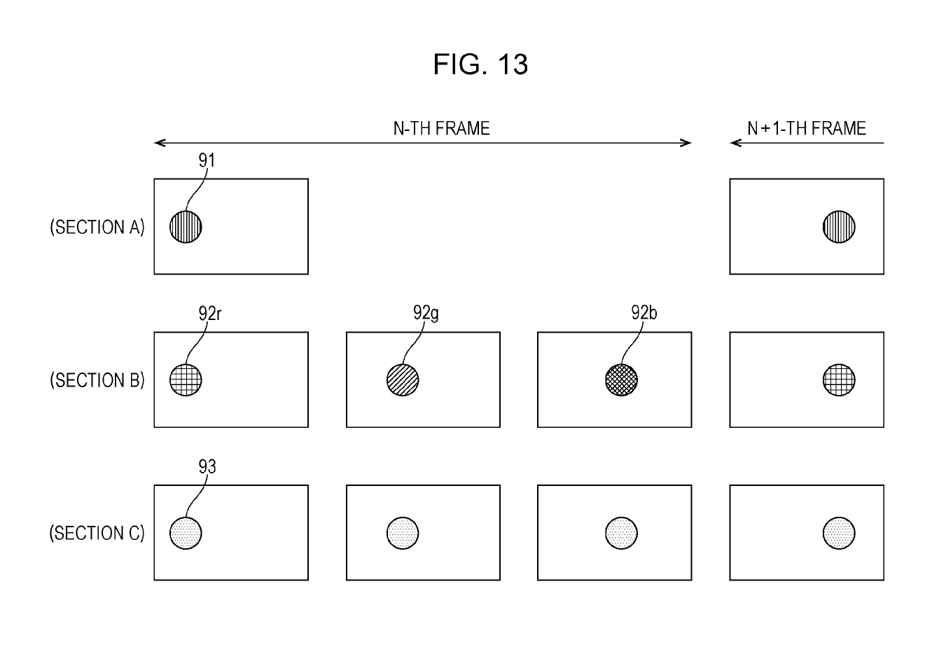

FIG. 13 is a diagram for describing an operation during each sub-frame period according to a second modification example of the first embodiment. More specifically, Section A of FIG. 13 shows frame images, Section B of FIG. 13 shows sub-frame images, and Section C of FIG. 13 shows diffusion state spots. In the modification example, the FS processing unit 12 performs a frame interpolation process based on the image data ID and the input signal IN. In the modification example, the configuration of the signal processing circuit 10 (the FS processing unit 12) may be one of the configuration thereof according to the foregoing first embodiment and the configuration thereof according to the first modification example, but the configuration according to the foregoing first modification example in which the display position of an image can be determined in real time is preferably adopted. Hereinafter, in the modification example, the description will be made by adopting the configuration of the signal processing circuit 10 according to the foregoing first modification example as the configuration of the signal processing circuit 10.

When the FS image data FID is generated based on the image data ID included in the input signal IN, the FS processing unit 12 performs frame interpolation using the sub-frame periods. For example, the FS processing unit 12 sets the second sub-frame image (a sub-frame image including the display spot 92g) and the third sub-frame image (a sub-frame image including the display spot 92b) of an N-th frame as frame interpolation images. Therefore, as shown in Section B of FIG. 13, the display spots 92r, 92g, and 92b are moved smoothly.

According to the modification example, since the frame interpolation is performed using the sub-frame periods, it is possible to smoothly display a moving image.

### 1.9 Third Modification Example

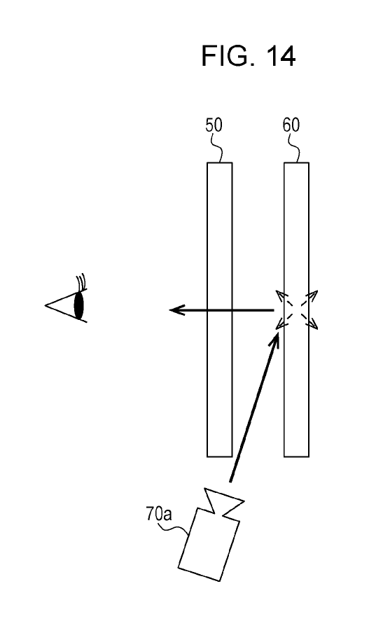

FIG. 14 is a sectional view corresponding to one pixel of the CF-less liquid crystal panel 50 and the PDLC panel 60 according to a third modification example of the first embodiment. As illustrated in FIG. 14, the first PDLC light source unit 70a according to the modification example radiates the light-source light to the front surface (one main surface) of the PDLC panel 60. The CF-less liquid crystal panel 50 is located on the front surface side of the PDLC panel 60. Therefore, in the modification example, an air layer or the like is preferably formed between the CF-less liquid crystal panel 50 and the PDLC panel 60 in order to allow the light-source light to be incident on the front surface of the PDLC panel 60.

In the embodiment, by radiating the light-source light to the front surface of the PDLC panel 60, it is possible to obtain the same advantageous effects as those of the foregoing first embodiment. When the diffusion effect in the reflection direction of the PDLC panel 60 is higher than the diffusion effect in the transmission direction, the light-source light of the first PDLC light source unit 70a is efficiently used for the image display. More specifically, the front-surface-direction vertical component of the diffused light-source light increases. Therefore, it is possible to improve the luminance of the display image.

### 1.10 Fourth Modification Example

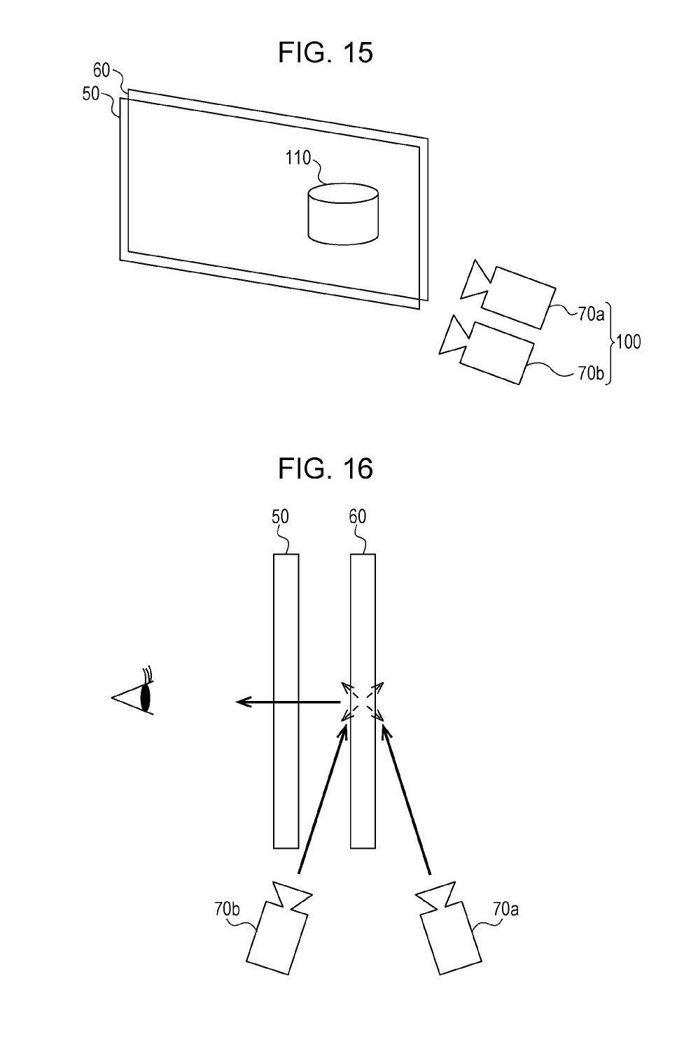

FIG. 15 is a perspective view for describing disposition of the CF-less liquid crystal panel 50, the PDLC panel 60, and first and second PDLC light source units 70a and 70b according to a fourth modification example of the first embodiment. In the modification example, the second PDLC light source unit 70b is added to the configuration of the foregoing first embodiment. The second PDLC light source unit 70b has the same configuration as the first PDLC light source unit 70a. The second PDLC light source unit 70b corresponds to a second light source unit for the second display panel. In the embodiment, the first PDLC light source unit 70a and the second PDLC light source unit 70b form the light source unit 100.

FIG. 16 is a sectional view corresponding to one pixel of the CF-less liquid crystal panel 50 and the PDLC panel 60 illustrated in FIG. 15. As illustrated in FIG. 16, the first PDLC light source unit 70a and the second PDLC light source unit 70b radiate the light-source light to the rear and front surfaces (both main surfaces) of the PDLC panel 60, respectively. As in the third modification example of the foregoing first embodiment, an air layer or the like is preferably formed between the CF-less liquid crystal panel 50 and the PDLC panel 60 in order to allow the light-source light to be incident on the front surface of the PDLC panel 60. The first PDLC light source unit 70a and the second PDLC light source unit 70b preferably radiate the light-source light to the mutually identical position.

In the modification example, since the light-source light is radiated to the rear and front surfaces of the PDLC panel 60, it is possible to improve the luminance of the display image irrespective of a magnitude relation between the diffusion effect in the reflection direction of the PDLC panel 60 and the diffusion effect in the transmission direction.

### 2. Second Embodiment

### 2.1 Light Guide Plate

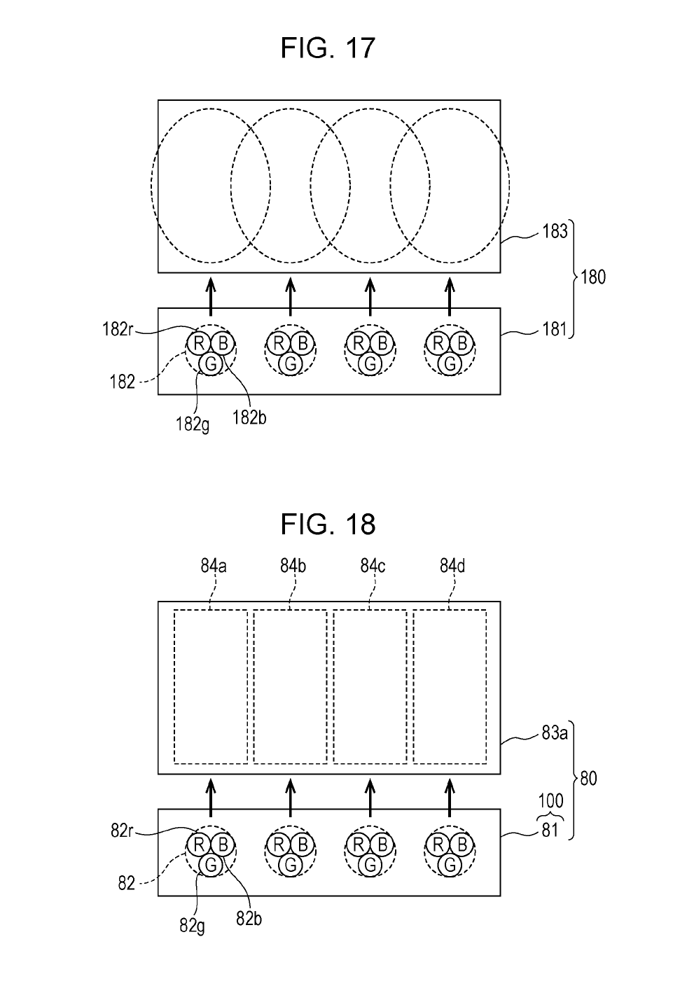

In a second embodiment of the invention, a light guide plate is used. Of the constituent elements of the embodiment, the same constituent elements as those of the foregoing first embodiment are denoted by the same reference numerals and the description thereof will be appropriately omitted. FIG. 17 is a diagram illustrating the configuration of a backlight unit 180 including a general light guide plate 183. The backlight unit 180 includes a light source unit 181 for a light guide plate and the light guide plate 183. The light source unit 181 for the light guide plate includes a plurality of light sources 182 which each include, for example, one red light-emitting element 182r, one green light-emitting element 182g, and a blue light-emitting element 182b. The configuration of the light source 182 is basically the same as the configuration of the above-described light source 71 and can be modified in various ways. The light guide plate 183 guides the light-source light emitted by the light source unit 181 for the light guide plate to emit the light-source light. As illustrated in FIG. 17, the general light guide plate 183 emits light, as a whole light guide plate 183, by guiding the incident light-source light without directivity.

FIG. 18 is a diagram illustrating the configuration of a backlight unit 80 according to the embodiment. The backlight unit 80 includes and a light guide plate 83a (hereinafter referred to as a “first light guide plate” for convenience) and a light source unit 81 for the light guide plate. The light source unit 81 for the light guide plate includes a plurality of light sources 82 which each include one red light-emitting element 82r, one green light-emitting element 82g, and one blue light-emitting element 82b. The configuration of the light source 82 is basically the same as the configuration of the above-described light source 71 and can be modified in various ways. In the embodiment, the light source unit 81 for the light guide plate forms the light source unit 100, and a PDLC panel 60 and the backlight unit 80 form the light radiation unit 90. The backlight unit 80 is driven by the light source driving circuit 40, as in the first PDLC light source unit 70a according to the foregoing first embodiment.

In the embodiment, the first light guide plate 83a is configured to be formed by a plurality (in FIG. 18, four) of blocks 84a to 84d arranged in one line. Each block guides the light-source light emitted from the corresponding light source 82 to emit the light-source light. The first light guide plate 83a guides the incident light-source light so that the light-source light with directivity is emitted for each block of the first light guide plate 83a. Therefore, area active-driving can be performed. The configuration of the first light guide plate 83a is disclosed in, for example, Japanese Unexamined Patent Application Publication No. 2008-34372. The blocks of the first light guide plate 83a can correspond to, for example, the division areas of the PDLC panel 60 described above.

### 2.2 Disposition of Panel and Light Guide Plate

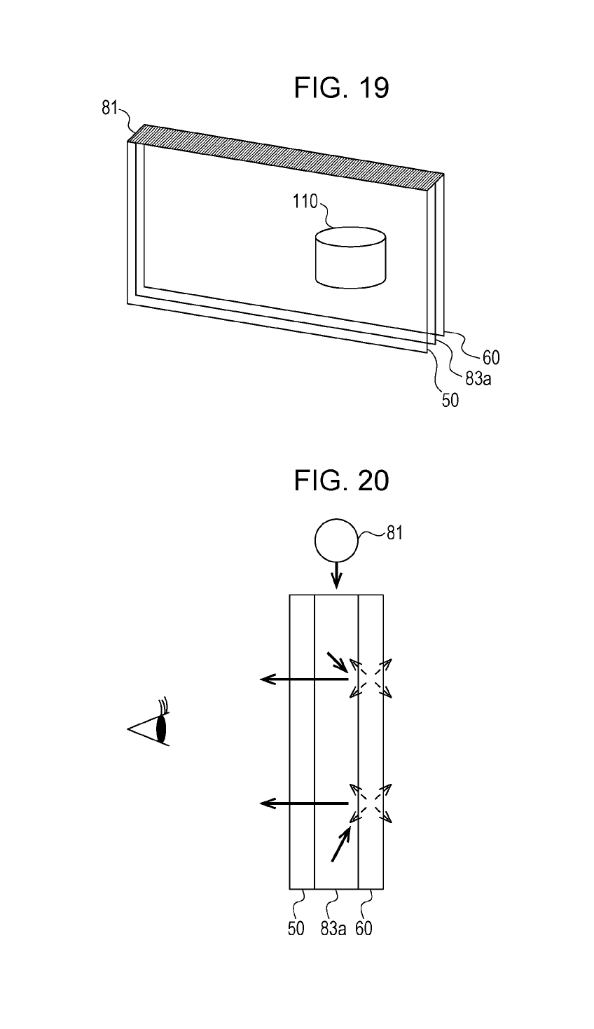

FIG. 19 is a perspective view for describing disposition of the CF-less liquid crystal panel 50, the PDLC panel 60, and the first light guide plate 83a according to the embodiment. As illustrated in FIG. 19, the first light guide plate 83a and the PDLC panel 60 are disposed in order on the side of the CF-less liquid crystal panel 50. That is, the first light guide plate 83a is located on the rear surface of the CF-less liquid crystal panel 50 and the PDLC panel 60 is located on the rear surface of the first light guide plate 83a. The light source unit 81 for the light guide plate is disposed in the upper end portion (the upper side of the sheet surface) of the first light guide plate 83a. The position of the light source unit 81 for the light guide plate is not limited to the example mentioned herein. The light source unit 81 for the light guide plate may be disposed in at least one of the lower end portion (the lower side of the sheet surface), the right end portion (the right side of the sheet surface), and the left end portion (the left side of the sheet surface) of the first light guide plate 83a. However, as described above, when the light-source light is emitted in accordance with in the scanning direction of the CF-less liquid crystal panel 50 and the PDLC panel 60, the light source unit 81 for the light guide plate is preferably disposed in one end or both ends of the first light guide plate 83a in an extension direction of the scanning line SL in the embodiment.

FIG. 20 is a sectional view corresponding to one pixel of the CF-less liquid crystal panel 50, the PDLC panel 60, and the first light guide plate 83a illustrated in FIG. 19. An air layer or the like may be formed between the CF-less liquid crystal panel 50 and the first light guide plate 83a and between the first light guide plate 83a and the PDLC panel 60. In the following description, the transmittance of the first light guide plate 83a is assumed to be relatively high.

At the time of the image display, no voltage is applied to the PDLC display elements 61 and the PDLC display elements 61 are in the diffusion state. At this time, the light-source light emitted by the light source unit 81 for the light guide plate is guided by the first light guide plate 83a and is emitted to each division area of interest of the CF-less liquid crystal panel 50 and the PDLC panel 60. More specifically, the light-source light is emitted from the light source unit 81 for the light guide plate to the block (hereinafter referred to as a “block of interest”) corresponding to the division area of interest and the light-source light guided by the block of interest is emitted to each division area of interest of the CF-less liquid crystal panel 50 and the PDLC panel 60. Therefore, the light-source light incident on the PDLC display elements 61 is diffused and the front-surface-direction vertical component of the diffused light-source light is transmitted through the first light guide plate 83a to be emitted to the CF-less liquid crystal display elements 51. The background light is also incident on the PDLC display elements 61. As described above, since the PDLC display elements 61 are in the diffusion state, the background light incident on the PDLC display elements 61 is diffused and the front-surface-direction vertical component of the diffused background light is transmitted through the first light guide plate 83a to be emitted to the CF-less liquid crystal display elements 51. Hereinafter, the light-source light emitted to the rear surface side of the first light guide plate 83a is referred to as “source light of rear surface emitted light” and the light-source light emitted to the front surface side of the first light guide plate 83a is referred to as “source light of front surface emitted light” to facilitate the description thereof.

In this way, at the time of the image display, the light radiation unit 90 formed by the PDLC panel 60 and the backlight unit 80 radiates light formed by the source light of the front surface emitted light, the front-surface-direction vertical component of the diffused source light of the rear surface emitted light, and the front-surface-direction vertical component of the diffused background light to the CF-less liquid crystal panel 50 (the CF-less liquid crystal display elements 51). At the time of the image display, since the PDLC panel 60 diffuses the background light, the background light arriving at the CF-less liquid crystal panel 50 has only the front-surface-direction vertical component after the diffusion. Therefore, an influence of the background light on the display image is sufficiently suppressed.

At the time of the entire surface non-display, a voltage is applied to the PDLC display elements 61 and the PDLC display elements 61 are in the transmission state. The light-source light is not emitted from the light source unit 81 for the light guide plate to any block of the first light guide plate 83a. Therefore, only the background light transmitted through the PDLC display elements 61 and the first light guide plate 83a is radiated to the CF-less liquid crystal display elements 51. Thus, the background is seen through.

At the time of the partial non-display, the PDLC display elements 61 are in the transmission state, as in the time of the entire surface non-display. Unlike the time of the entire surface non-display, on the other hand, the light-source light is not emitted from the light source unit 81 for the light guide plate to the blocks of interest and the light-source light is emitted from the light source unit 81 for the light guide plate to the other blocks. In this way, the background light transmitted through the PDLC display elements 61 and the first light guide plate 83a is radiated to the CF-less liquid crystal display elements 51 of the division area in which the image display is not performed. Light formed by the source light of the front surface emitted light, the front-surface-direction vertical component of the diffused source light of the rear surface emitted light, and the front-surface-direction vertical component of the diffused background light is radiated to the CF-less liquid crystal display elements 51 of the division area in which the image display is performed. Therefore, the image display and the background transmission can be simultaneously performed and the spot in which the image display is performed and the spot in which the background transmission is performed can be allowed to appropriately coexist in one screen.

Incidentally, light guide plates can broadly be classified into two kinds of front-light light guide plates and backlight light guide plates. Even in the two kinds of light guide plates, the light-source light is emitted to both of the front and rear surface sides. Therefore, the first light guide plate 83a adopted in the above-described configuration may be either of the front-light light guide plate and the backlight light guide plate. In the front-light light guide plate, the source light of the rear surface emitted light is greater and the source light of the front surface emitted light is smaller than the backlight light guide plate. The configuration of the front-light light guide plate is disclosed in, for example, Japanese Unexamined Patent Application Publication No. 2006-106614.

### 2.3 Advantageous Effects

According to the embodiment, the light-source light emitted by the light source unit 81 for the light guide plate is radiated to the PDLC panel 60 via the first light guide plate 83a. By controlling the transmittance of the diffused light by the CF-less liquid crystal panel 50, the image display is performed. Thus, it is possible to obtain the same advantageous effects as those of the foregoing first embodiment.

According to the embodiment, since the first light guide plate 83a formed by the blocks is used, the light-source light can be allowed to be radiated to the spot in the diffusion state in the PDLC panel 60 and not to be radiated to the spot in the transmission state. Therefore, the spot in which the image display is performed and the spot in which the background is seen through can be allowed to appropriately coexist in one screen. Since the light-source light can be radiated to each division area by the first light guide plate 83a formed by the blocks, the area active-driving can be performed as in the foregoing first embodiment. Through the area active-driving, as in the FS driving, it is possible to suppress so-called color breakup which easily occurs when a screen of another color component is switched at a high speed. Since the light-source light can be emitted from the block in accordance with the scanning directions of the CF-less liquid crystal panel 50 and the PDLC panel 60, it is possible to suppress the above-described color irregularity further than when the light-source light is uniformly emitted to the entire surface of the PDLC panel 60. At this time, the scanning of the light-source light may not necessarily be tuned with the scanning direction of the PDLC panel 60. By tuning the scanning of the light-source light with the scanning direction of the CF-less liquid crystal panel 50, it is possible to suppress the foregoing color irregularity.

According to the embodiment, when the diffusion effect in the reflection direction of the PDLC panel 60 is higher than the diffusion effect in the transmission direction, the source light of the rear surface emitted light of the first light guide plate 83a can be efficiently used for the image display by disposing the first light guide plate 83a and the PDLC panel 60 in order on the side of the CF-less liquid crystal panel 50. More specifically, the front-surface-direction vertical component of the diffused source light of the rear surface emitted light increases. Therefore, it is possible to improve the luminance of the display image. Further, since the front-surface-direction vertical component of the diffused background light decreases, it is possible to sufficiently suppress the influence of the background light on the display image.

### 2.4 First Modification Example

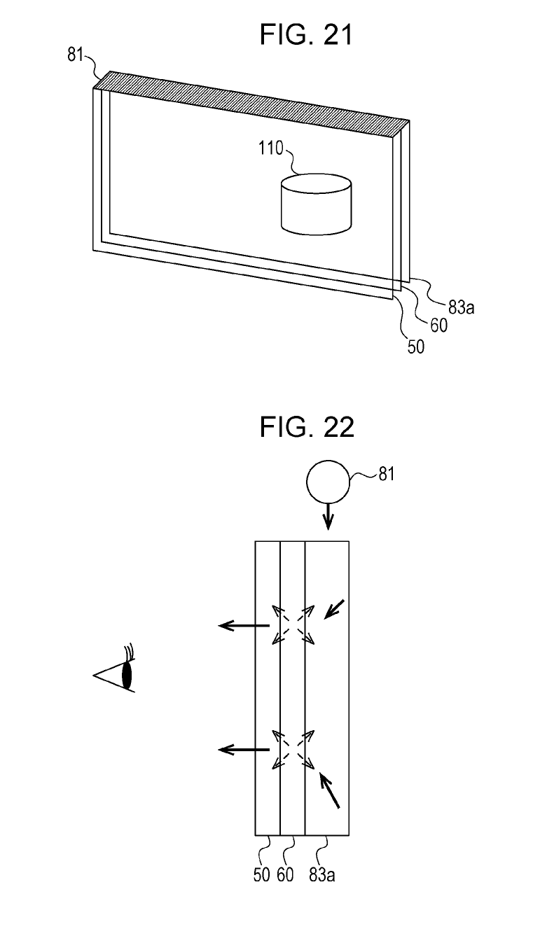

FIG. 21 is a perspective view for describing a disposition order of the CF-less liquid crystal panel 50, the PDLC panel 60, and the first light guide plate 83a according to a first modification example of the second embodiment. In the modification example, the PDLC panel 60 and the first light guide plate 83a are disposed in order on the side of the CF-less liquid crystal panel 50. That is, the PDLC panel 60 is located on the rear surface of the CF-less liquid crystal panel 50 and the first light guide plate 83a is located on the rear surface of the PDLC panel 60.

FIG. 22 is a sectional view corresponding to one pixel of the CF-less liquid crystal panel 50, the PDLC panel 60, and the first light guide plate 83a illustrated in FIG. 21. At the time of the image display, no voltage is applied to the PDLC display elements 61 and the PDLC display elements 61 are in the diffusion state. At this time, the light-source light emitted by the light source unit 81 for the light guide plate is guided by the first light guide plate 83a and is emitted to the division area of interest of the PDLC panel 60 located on the front surface. More specifically, the light-source light is emitted from the light source unit 81 for the light guide plate to the block of interest and the light-source light guided by the block of interest is emitted to the division area of interest of the PDLC panel 60. Therefore, the light-source light incident on the PDLC display elements 61 is diffused and the front-surface-direction vertical component of the diffused light-source light is emitted to the CF-less liquid crystal display elements 51. The background light transmitted through the first light guide plate 83a is also incident on the PDLC display elements 61. As described above, since the PDLC display elements 61 are in the diffusion state, the background light incident on the PDLC display elements 61 is diffused and the front-surface-direction vertical component of the diffused background light is emitted to the CF-less liquid crystal display elements 51. In the modification example, since the source light of the rear surface emitted light does not arrive at the CF-less liquid crystal display elements 51, the source light of the rear surface emitted light does not contribute to the image display.

In this way, at the time of the image display, the light radiation unit 90 formed by the PDLC panel 60 and the backlight unit 80 radiates light formed by the front-surface-direction vertical component of the diffused source light of the front surface emitted light and the front-surface-direction vertical component of the diffused background light to the CF-less liquid crystal panel 50 (the CF-less liquid crystal display elements 51). At the time of the image display, since the PDLC panel 60 diffuses the background light, the background light arriving at the CF-less liquid crystal panel 50 has only the front-surface-direction vertical component after the diffusion. Therefore, an influence of the background light on the display image is sufficiently suppressed.

At the time of the entire surface non-display, a voltage is applied to the PDLC display elements 61 and the PDLC display elements 61 are in the transmission state. The light-source light is not emitted from the light source unit 81 for the light guide plate to any block of the first light guide plate 83a. Therefore, only the background light transmitted through the PDLC display elements 61 and the first light guide plate 83a is radiated to the CF-less liquid crystal display elements 51. Thus, the background is seen through.

At the time of the partial non-display, the PDLC display elements 61 are in the transmission state, as in the time of the entire surface non-display. Unlike the time of the entire surface non-display, on the other hand, the light-source light is not emitted from the light source unit 81 for the light guide plate to the blocks of interest and the light-source light is emitted from the light source unit 81 for the light guide plate to the other blocks. In this way, the background light transmitted through the PDLC display elements 61 and the first light guide plate 83a are radiated to the CF-less liquid crystal display elements 51 of the division area in which the image display is not performed. Light formed by the front-surface-direction vertical component of the diffused source light of the front surface emitted light and the front-surface-direction vertical component of the diffused background light is radiated to the CF-less liquid crystal display elements 51 of the division area in which the image display is performed. Therefore, as in the foregoing second embodiment, the image display and the background transmission can be simultaneously performed and the spot in which the image display is performed and the spot in which the background is seen through can be allowed to appropriately coexist in one screen.

In the modification example, by disposing the PDLC panel 60 and the first light guide plate 83a in order on the side of the CF-less liquid crystal panel 50, it is possible to obtain the same advantageous effects as those of the foregoing second embodiment. When the diffusion effect in the transmission direction of the PDLC panel 60 is higher than the diffusion effect in the reflection direction, the source light of the front surface emitted light of the first light guide plate 83a is efficiently used for the image display. More specifically, the front-surface-direction vertical component of the source light of the front surface emitted light increases. Therefore, it is possible to improve the luminance of the display image. In the modification example, when the backlight light guide plate in which the source light of the front surface emitted light is more than the source light of the rear surface emitted light is adopted as the foregoing first light guide plate 83a, it is possible to further improve the luminance of the display image.

### 2.5 Second Modification Example

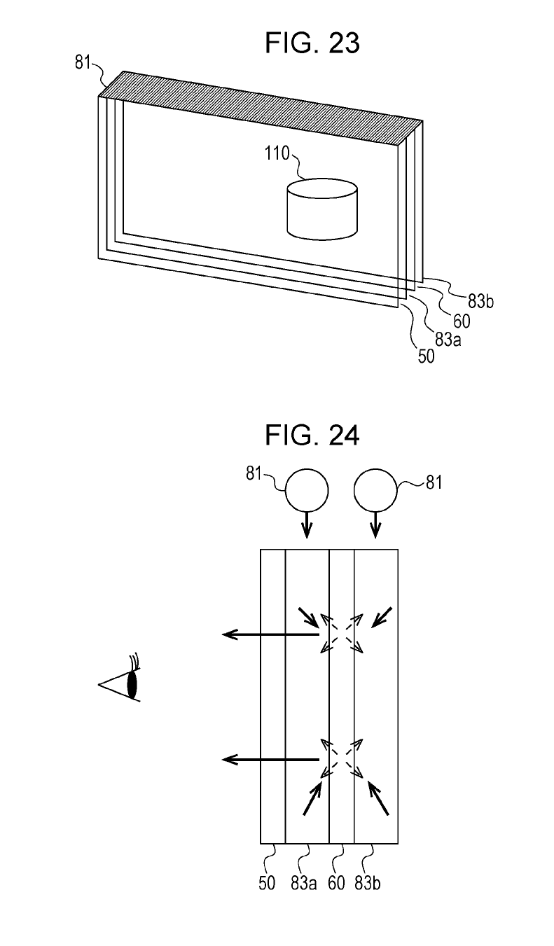

FIG. 23 is a perspective view for describing a disposition order of the CF-less liquid crystal panel 50, the PDLC panel 60, and first and second light guide plates 83a and 83b according to a second modification example of the second embodiment. The characteristics of the first and second light guide plates 83a and 83b may be mutually identical to each other or may be different from each other. However, the transmittance of the second light guide plate 83b is assumed to be relatively higher as in the transmittance of the first light guide plate 83a. The second light guide plate 83b is configured to be formed by a plurality of blocks arranged in one line, as in the first light guide plate 83a. Hereinafter, as in the first light guide plate 83a, the light-source light emitted to the rear surface side of the second light guide plate 83b is referred to as “source light of rear surface emitted light” and the light-source light emitted to the front surface side of the second light guide plate 83b is referred to as “source light of front surface emitted light” to facilitate the description. In the modification example, the first light guide plate 83a, the PDLC panel 60, and the second light guide plate 83b are disposed in order on the side of the CF-less liquid crystal panel 50. That is, the first light guide plate 83a is located on the rear surface of the CF-less liquid crystal panel 50, the PDLC panel 60 is located on the rear surface of the first light guide plate 83a, and the second light guide plate 83b is located on the rear surface of the PDLC panel 60.

FIG. 24 is a sectional view corresponding to one pixel of the CF-less liquid crystal panel 50, the PDLC panel 60, and the first and second light guide plates 83a and 83b illustrated in FIG. 23. At the time of the image display, no voltage is applied to the PDLC display elements 61 and the PDLC display elements 61 are in the diffusion state. At this time, the light-source light emitted by the light source unit 81 for the light guide plate is guided by the first and second light guide plates 83a and 83b and is emitted to each division area of interest of the CF-less liquid crystal panel 50 and the PDLC panel 60. More specifically, the light-source light is emitted from the light source unit 81 for the light guide plate to the blocks of interest of the first and second light guide plates 83a and 83b. The light-source light guided by the first light guide plate 83a is emitted to each division area of interest of the CF-less liquid crystal panel 50 and the PDLC panel 60 and the light-source light guide by the second light guide plate 83b is emitted to the division area of interest of the PDLC panel 60. Therefore, the light-source light incident on the PDLC display elements 61 is diffused and the front-surface-direction vertical component of the diffused light-source light is transmitted through the first light guide plate 83a to be emitted to the CF-less liquid crystal display elements 51. The source light of the front surface emitted light of the first light guide plate 83a is emitted to the CF-less liquid crystal display elements 51. The background light transmitted through the second light guide plate 83b is also incident on the PDLC display elements 61. As described above, since the PDLC display elements 61 are in the diffusion state, the background light incident on the PDLC display elements 61 is diffused and the front-surface-direction vertical component of the diffused background light is transmitted through the first light guide plate 83a to be emitted to the CF-less liquid crystal display elements 51. Since the source light of the rear surface emitted light of the second light guide plate 83b does not arrive at the CF-less liquid crystal display elements 51, the source light of the rear surface emitted light does not contribute to the image display.

In this way, at the time of the image display, the light radiation unit 90 formed by the PDLC panel 60 and the backlight unit 80 radiates light formed by the source light of the front surface emitted light of the first light guide plate 83a, the front-surface-direction vertical components of the diffused source light of the rear surface emitted light of the first light guide plate 83a and the source light of the front surface emitted light of the second light guide plate 83b, and the front-surface-direction vertical component of the diffused background light to the CF-less liquid crystal panel 50 (the CF-less liquid crystal display elements 51). At the time of the image display, since the PDLC panel 60 diffuses the background light, the background light arriving at the CF-less liquid crystal panel 50 has only the front-surface-direction vertical component after the diffusion. Therefore, an influence of the background light on the display image is sufficiently suppressed.

At the time of the entire surface non-display, a voltage is applied to the PDLC display elements 61 and the PDLC display elements 61 are in the transmission state. The light-source light is not emitted from the light source unit 81 for the light guide plate to any block of the first light guide plate 83a or any block of the second light guide plate 83b. Therefore, only the background light transmitted through second light guide plate 83b, the PDLC display elements 61, and the first light guide plate 83a is radiated to the CF-less liquid crystal display elements 51. Thus, the background is seen through.

At the time of the partial non-display, the PDLC display elements 61 are in the transmission state, as in the time of the entire surface non-display. Unlike the time of the entire surface non-display, on the other hand, the light-source light is not emitted from the light source unit 81 for the light guide plate to the blocks of interest of the first and second light guide plates 83a and 83b and the light-source light is emitted from the light source unit 81 for the light guide plate to the other blocks of the first and second light guide plates 83a and 83b. In this way, the background light transmitted through the second light guide plate 83b, the PDLC display elements 61, and the first light guide plate 83a is radiated to the CF-less liquid crystal display elements 51 of the division area in which the image display is not performed. Light formed by the source light of the front surface emitted light of the first light guide plate 83a, the front-surface-direction vertical components of the diffused source light of the rear surface emitted light of the first light guide plate 83a and the source light of the front surface emitted light of the second light guide plate 83b, and the front-surface-direction vertical component of the diffused background light is radiated to the CF-less liquid crystal display elements 51 of the division area in which the image display is performed. Therefore, the image display and the background transmission can be simultaneously performed and the spot in which the image display is performed and the spot in which the background is seen through can be allowed to appropriately coexist in one screen.

In the modification example, by disposing the first light guide plate 83a, the PDLC panel 60, and the second light guide plate 83b in order on the side of the CF-less liquid crystal panel 50, it is possible to obtain the same advantageous effects as those of the foregoing second embodiment. In the modification example, the source light of the rear surface emitted light and the source light of the front surface emitted light respectively emitted from the first and second light guide plates 83a and 83b are diffused in the PDLC panel 60, and the front-surface-direction vertical components thereof are radiated to the CF-less liquid crystal panel 50. Therefore, it is possible to improve the luminance of the display image irrespective of a magnitude relation between the diffusion effect in the reflection direction of the PDLC panel 60 and the diffusion effect in the transmission direction.

### 3. Third Embodiment

### 3.1 Disposition of Panel, Light Source Unit, and Light Guide Unit

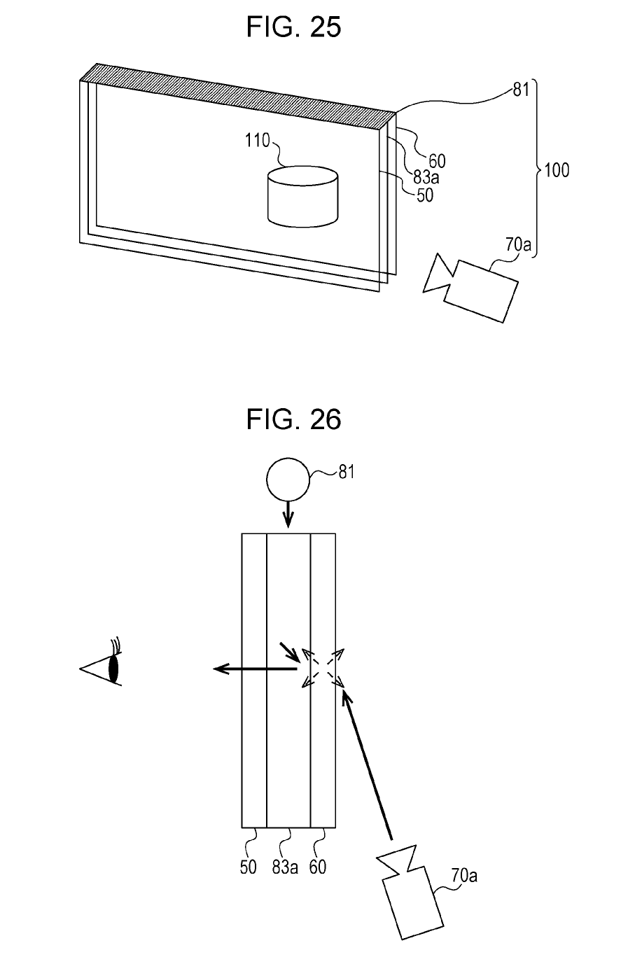

FIG. 25 is a perspective view for describing disposition of the CF-less liquid crystal panel 50, the PDLC panel 60, the first PDLC light source unit 70a, and the first light guide plate 83a according to a third embodiment of the invention. Of the constituent elements of the embodiment, the same constituent elements as those of the foregoing first or second embodiment are denoted by the same reference numerals and the description thereof will be appropriately omitted. In the embodiment, the first PDLC light source unit 70a in the foregoing first embodiment is used together in order to improve the luminance of the spot in which the image display is performed in the foregoing second embodiment. In the embodiment, the disposition of the CF-less liquid crystal panel 50, the PDLC panel 60, the first light guide plate 83a, and the light source unit 81 for the light guide plate is the same as that of the foregoing second embodiment. In the embodiment, the disposition of the first PDLC light source unit 70a is the same as that of the foregoing first embodiment. In the embodiment, the first PDLC light source unit 70a and the light source unit 81 for the light guide plate form the light source unit 100. The first PDLC light source unit 70a and the light source unit 81 for the light guide plate are driven in synchronization with the light source driving circuit 40.

FIG. 26 is a sectional view corresponding to one pixel of the CF-less liquid crystal panel 50, the PDLC panel 60, and the first light guide plate 83a illustrated in FIG. 25. In the embodiment, the first PDLC light source unit 70a radiates the light-source light to the rear surface of the PDLC panel 60. More specifically, at the time of the image display or the time of the partial non-display, the first PDLC light source unit 70a radiates the light-source light from the rear surface to the PDLC display elements 61 in the division area in which the image display is performed. Therefore, in the embodiment, the front-surface-direction vertical component of the diffused light-source light of the first PDLC light source unit 70a is added to the light radiated to the CF-less liquid crystal display elements 51 of the division area in which the image display is performed in the foregoing second embodiment. Since the other basic configuration and operations are the same as those of the first or second embodiment, the description thereof will be omitted.

### 3.2 Advantageous Effect

In the embodiment, by using the first PDLC light source unit 70a together in the configuration of the foregoing second embodiment, the front-surface-direction vertical component of the diffused light-source light of the first PDLC light source unit 70a is added to the light radiated to the CF-less liquid crystal display elements 51 of the division area in which the image display is performed. Therefore, it is possible to improve the luminance of the display image.

### 3.3 First Modification Example

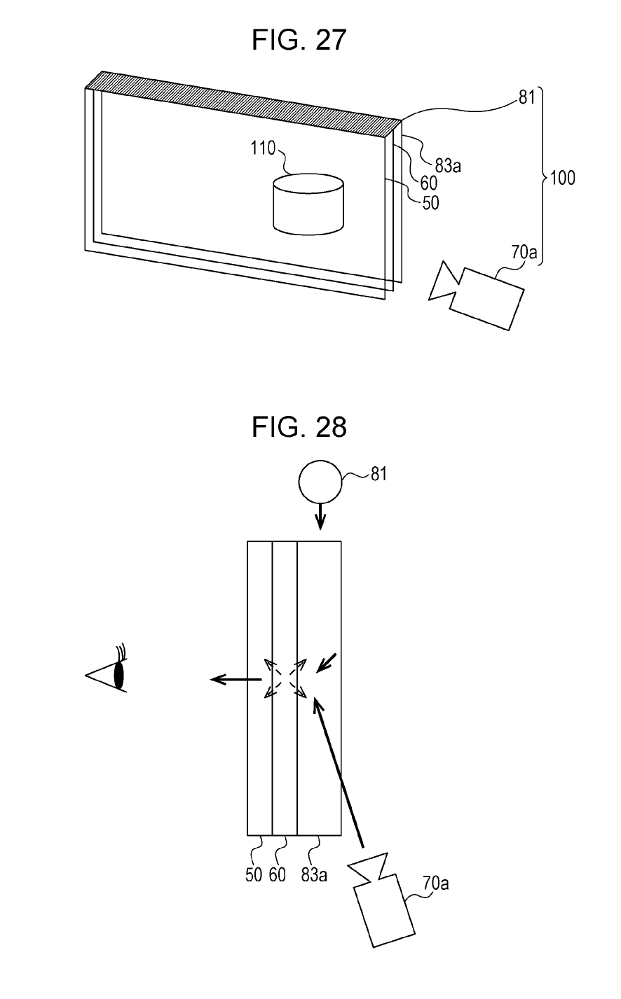

FIG. 27 is a perspective view for describing disposition of the CF-less liquid crystal panel 50, the PDLC panel 60, the first PDLC light source unit 70a, and the first light guide plate 83a according to a first modification example of the third embodiment of the invention. In the modification example, the first PDLC light source unit 70a in the foregoing first embodiment is used together to improve the luminance of the spot in which the image display is performed in the first modification example of the foregoing second embodiment. In the modification example, the disposition of the CF-less liquid crystal panel 50, the PDLC panel 60, the first light guide plate 83a, and the light source unit 81 for the light guide plate is the same as that of the first modification example of the foregoing second embodiment.

FIG. 28 is a sectional view corresponding to one pixel of the CF-less liquid crystal panel 50, the PDLC panel 60, and the first light guide plate 83a illustrated in FIG. 27. In the modification example, the first PDLC light source unit 70a radiates the light-source light to the rear surface of the PDLC panel 60. The light-source light of the first PDLC light source unit 70a may be radiated to the rear surface of the PDLC panel 60 via the first light guide plate 83a and may be radiated directly to the rear surface of the PDLC panel 60 by forming an air layer or the like between the first light guide plate 83a and the PDLC panel 60. More specifically, at the time of the image display or the time of the partial non-display, the first PDLC light source unit 70a radiates the light-source light from the rear surface to the PDLC display elements 61 in the division area in which the image display is performed. Therefore, in the modification example, the front-surface-direction vertical component of the diffused light-source light of the first PDLC light source unit 70a is added to the light radiated to the CF-less liquid crystal display elements 51 of the division area in which the image display is performed in the first modification example of the foregoing second embodiment. Since the other basic configuration and operations are the same as those of the first modification example of the first embodiment or the second embodiment, the description thereof will be omitted.

In the modification example, by using the first PDLC light source unit 70a together in the configuration of the first modification example of the foregoing second embodiment, the front-surface-direction vertical component of the diffused light-source light of the first PDLC light source unit 70a is added to the light radiated to the CF-less liquid crystal display elements 51 of the division area in which the image display is performed. Therefore, it is possible to improve the luminance of the display image.

### 3.4 Second Modification Example

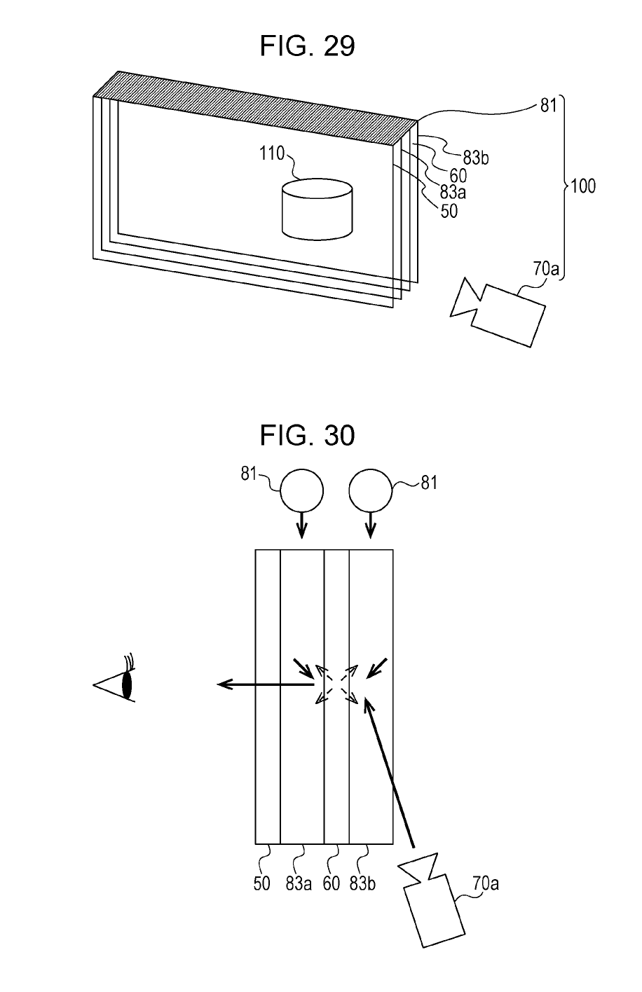

FIG. 29 is a perspective view for describing disposition of the CF-less liquid crystal panel 50, the PDLC panel 60, the first PDLC light source unit 70a, and first and second light guide plates 83a and 83b according to a second modification example of the third embodiment. In the modification example, the first PDLC light source unit 70a in the foregoing first embodiment is used together in order to improve the luminance of the spot in which the image display is performed in the second modification example of the foregoing second embodiment. In the modification example, the disposition of the CF-less liquid crystal panel 50, the PDLC panel 60, the first and second light guide plates 83a and 83b, and the light source unit 81 for the light guide plate is the same as that of the second modification example of the foregoing second embodiment.

FIG. 30 is a sectional view corresponding to one pixel of the CF-less liquid crystal panel 50, the PDLC panel 60, and the first and second light guide plates 83a and 83b illustrated in FIG. 29. In the modification example, the first PDLC light source unit 70a radiates the light-source light to the rear surface of the PDLC panel 60. The light-source light of the first PDLC light source unit 70a may be radiated to the rear surface of the PDLC panel 60 via the second light guide plate 83b and may be radiated directly to the rear surface of the PDLC panel 60 by forming an air layer or the like between the second light guide plate 83b and the PDLC panel 60. More specifically, at the time of the image display or the time of the partial non-display, the first PDLC light source unit 70a radiates the light-source light from the rear surface to the PDLC display elements 61 in the division area in which the image display is performed. Therefore, in the modification example, the front-surface-direction vertical component of the diffused light-source light of the first PDLC light source unit 70a is added to the light radiated to the CF-less liquid crystal display elements 51 of the division area in which the image display is performed in the second modification example of the foregoing second embodiment. Since the other basic configuration and operations are the same as those the second modification example of the first embodiment or the second embodiment, the description thereof will be omitted.

In the modification example, by using the first PDLC light source unit 70a together in the configuration of the second modification example of the foregoing second embodiment, the front-surface-direction vertical component of the diffused light-source light of the first PDLC light source unit 70a is added to the light radiated to the CF-less liquid crystal display elements 51 of the division area in which the image display is performed. Therefore, it is possible to improve the luminance of the display image.

### 4. Fourth Embodiment

### 4.1 Color Irregularity

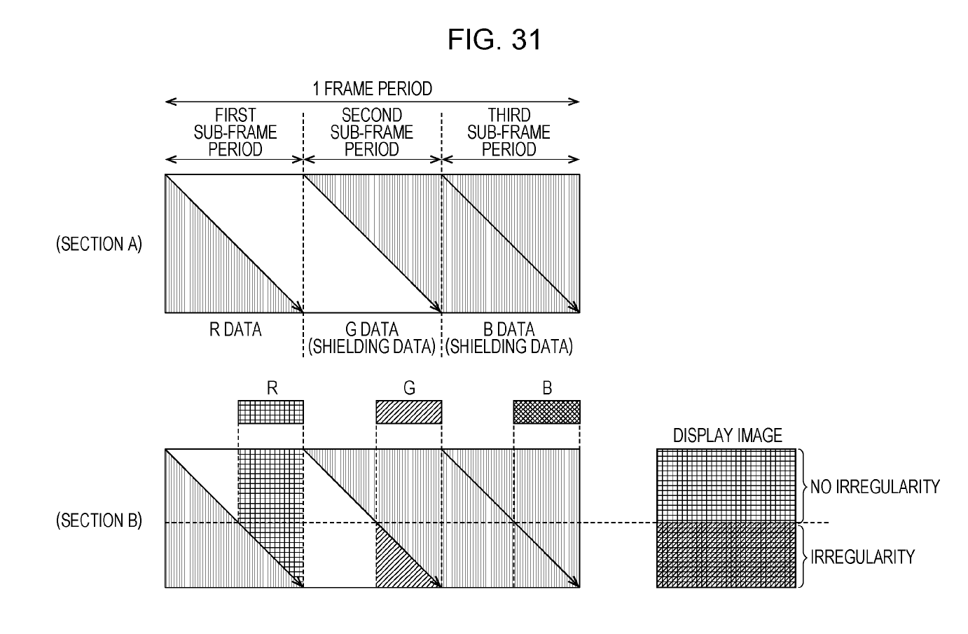

In a fourth embodiment of the invention, the above-described color irregularity is resolved which occurs when the scanning driving of the light source is not performed in accordance with the scanning direction of the CF-less liquid crystal panel 50. Here, the color irregularity will be further described. In the description of the factors relevant to the color irregularity in the embodiment, note that the factors are omitted in some cases to facilitate the description of the driving of the PDLC panel 60. FIG. 31 is a diagram for describing color irregularity. More specifically, Section A of FIG. 31 shows a timing at which red data is supplied to the CF-less liquid crystal panel 50 and Section B of FIG. 31 shows a light-up start time and a light-up time at which a light-emitting element of each color lights up. Section A of FIG. 31 is the same as Section A of FIG. 9 described above. In Section B of FIG. 31, a schematic display image is added to Section C of FIG. 9 described above.

Since an operation in each sub-frame period is the same as the operation described above, the description thereof will be omitted herein. As shown in Section B of FIG. 31, a red image with no color irregularity is displayed in the upper half of a screen and an image with color irregularity in which green is mixed with red is displayed in the lower half of the screen.

### 4.2 Signal Processing Circuit

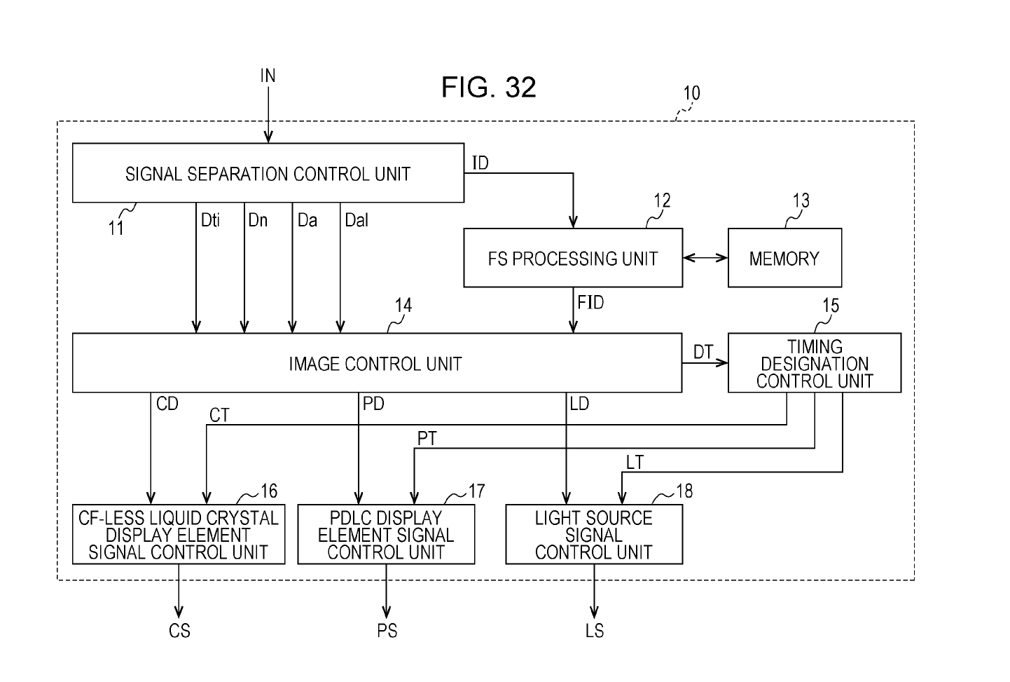

FIG. 32 is a block diagram illustrating the configuration of the signal processing circuit 10 according to the embodiment. Of the constituent elements of the embodiment, the same constituent elements as those of the foregoing first to third embodiments are denoted by the same reference numerals and the description thereof will be appropriately omitted. The basic configuration of the signal processing circuit 10 according to the embodiment is the same as that of the foregoing first embodiment. An input signal IN in the embodiment includes image data ID, display image position designation data Da, display start line designation data Dal, non-display start line designation data Dn, and response time data Dti indicating a liquid crystal response time Tl of the CF-less liquid crystal panel 50.

The display start line designation data Dal is data for designating a start position (hereinafter referred to as a “display start line” and denoted by reference numeral Xa) of a display area in which an image with no color irregularity and a desired color is displayed on a screen by adjusting at least one of a light-up time of the light-emitting element of each color, a scanning driving start time of the CF-less liquid crystal display elements 51, and a light-up time of the light-emitting element of each color. The non-display start line designation data Dn is data for designating a start position (hereinafter referred to as a “non-display start line” and denoted by a reference numeral Xn) of a non-display area in which the image with the desired color is not displayed on the screen by allowing the color data to be the same for each sub-frame period or each pixel.

The signal separation control unit 11 separates the input signal IN into the image data ID, the display image position designation data Da, the display start line designation data Dal, the non-display start line designation data Dn, and the response time data Dti, supplies the image data ID to the FS processing unit 12, and supplies the display image position designation data Da, the display start line designation data Dal, the non-display start line designation data Dn, and the response time data Dti to the image control unit 14.

The image control unit 14 generates CF-less liquid crystal data CD, PDLC data PD, light source data LD, and a driving timing control signal DT based on the display image position designation data Da, the display start line designation data Dal, the non-display start line designation data Dn, the response time data Dti, and the FS image data FID.

### 4.3 Image Control Unit

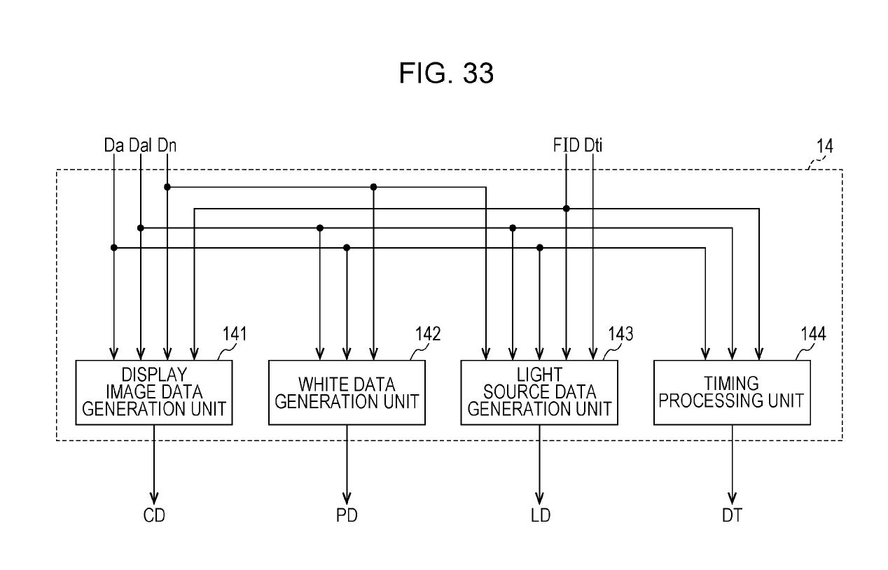

FIG. 33 is a block diagram illustrating the configuration of the image control unit 14 illustrated in FIG. 32. The basic configuration of the image control unit 14 in the embodiment is the same as that of the foregoing first embodiment. The display image data generation unit 141 receives the display image position designation data Da, the display start line designation data Dal, the non-display start line designation data Dn, and the FS image data FID and generates the CF-less liquid crystal data CD based on the display image position designation data Da, the display start line designation data Dal, the non-display start line designation data Dn, and the FS image data FID. The CF-less liquid crystal data CD in the embodiment includes image data (color data) for a display area and image data (color data) for a non-display area. The white data generation unit 142 receives the display image position designation data Da, the display start line designation data Dal, and the non-display start line designation data Dn and generates the PDLC data PD based on the display image position designation data Da, the display start line designation data Dal, and the non-display start line designation data Dn. The light source data generation unit 143 receives the display image position designation data Da, the display start line designation data Dal, the non-display start line designation data Dn, the response time data Dti, and the FS image data FID and generates the light source data LD based on the display image position designation data Da, the display start line designation data Dal, the non-display start line designation data Dn, the response time data Dti, and the FS image data FID. The light source data generation unit 143 generates a light source light-up time data Dtb to be described below and supplies the light source light-up time data Dtb to the timing processing unit 144. The timing processing unit 144 receives the display image position designation data Da, the display start line designation data Dal, the FS image data FID, and the light source light-up time data Dtb and generates the driving timing control signal DT based on the display image position designation data Da, the display start line designation data Dal, the FS image data FID, and the light source light-up time data Dtb.

An operation of the light source data generation unit 143 in the embodiment will be further described. The light source data generation unit 143 obtains a maximum light source light-up time Tbm which is a time at which the light-emitting element of each color lights up so that the luminance becomes the maximum in the state of no color irregularity by expression (1), (2), or (3) below by using at least the display start line designation data Dal, the non-display start line designation data Dn, and the response time data Dti:

Tbm=T−Tl−[T*(Xn−Xa)]/X (1);

Tbm=T (2); and

Tbm=T−Tl−[T*(X+Xn−Xa)]/X (3),

where T indicates one sub-frame period and X indicates the total number of lines (total number of scanning lines) of the CF-less liquid crystal panel 50.

Whether calculation is performed using one of expressions (1) to (3) above is determined by a magnitude relation between a display start line Xa and a non-display start line Xn. Specifically, when Xa<Xn, expression (1) is used. When Xa=Xn, expression (2) is used. When Xa Xn, expression (3) is used. A light source light-up time Tb which is a period in which the light-emitting elements light up can be changed between the maximum light source light-up time Tbm and 0. In order to obtain higher luminance, the light source light-up time Tb is preferably set to a value closer to the maximum light source light-up time Tbm. The light source data LD output by the light source data generation unit 143 includes the light source light-up time Tb. The light source data LD may include the maximum light source light-up time Tbm instead of the light source light-up time Tb. The light source data generation unit 143 supplies the light source light-up time data Dtb indicating the light source light-up time Tb to the timing processing unit 144.

Next, an operation of the timing processing unit 144 in the embodiment will be further described. The timing processing unit 144 obtains a light-up driving adjustment time Td which is a time for determining how much quickly or how much lately the light-emitting element of each color lights up from the scanning driving start time of the CF-less liquid crystal display element 51 by equation (4) below by using at least the display start line designation data Dal and the light source light-up time data Dtb. In other words, the light-up driving adjustment time Td is a time for adjusting the light-up start time of the light-emitting element of each color.

Td=T−Tb+(T*Xa/X) (4)

The timing processing unit 144 generates and outputs the driving timing control signal DT based on the light-up driving adjustment time Td obtained by expression (4). The start time of the scanning driving of the CF-less liquid crystal display elements 51 may be adjusted instead of adjusting the light-up start time of the light-emitting element of each color. Further, both of the light-up start time of the light-emitting element of each color and the start time of the scanning driving of the CF-less liquid crystal display element 51 may be adjusted. For the maximum light source light-up time Tbm and the light-up driving adjustment time Td indicated in expressions (1) to (4) above, a case in which the maximum luminance is displayed in a state of no color irregularity is assumed. However, when the color irregularity is allowed slightly, each of the maximum light source light-up time Tbm and the light-up driving adjustment time Td may be increased or decreased by an allowable amount. In the embodiment, the driving timing control signal DT corresponds to a light source driving timing control signal.

By lighting up the light-emitting elements of the respective colors of the first PDLC light source unit 70a and/or the backlight unit 80 in order in synchronization with the driving of the CF-less liquid crystal panel 50 under the above-described setting, it is possible to form a display area in which an image with no color irregularity is displayed at a desired position on the screen.

### 4.4 Operation

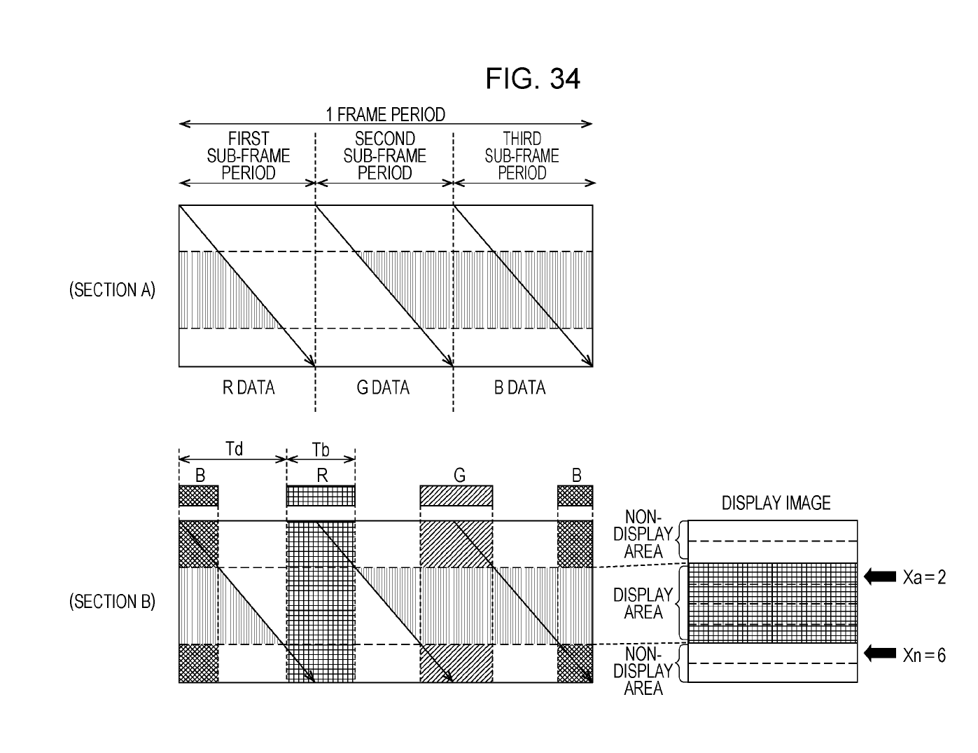

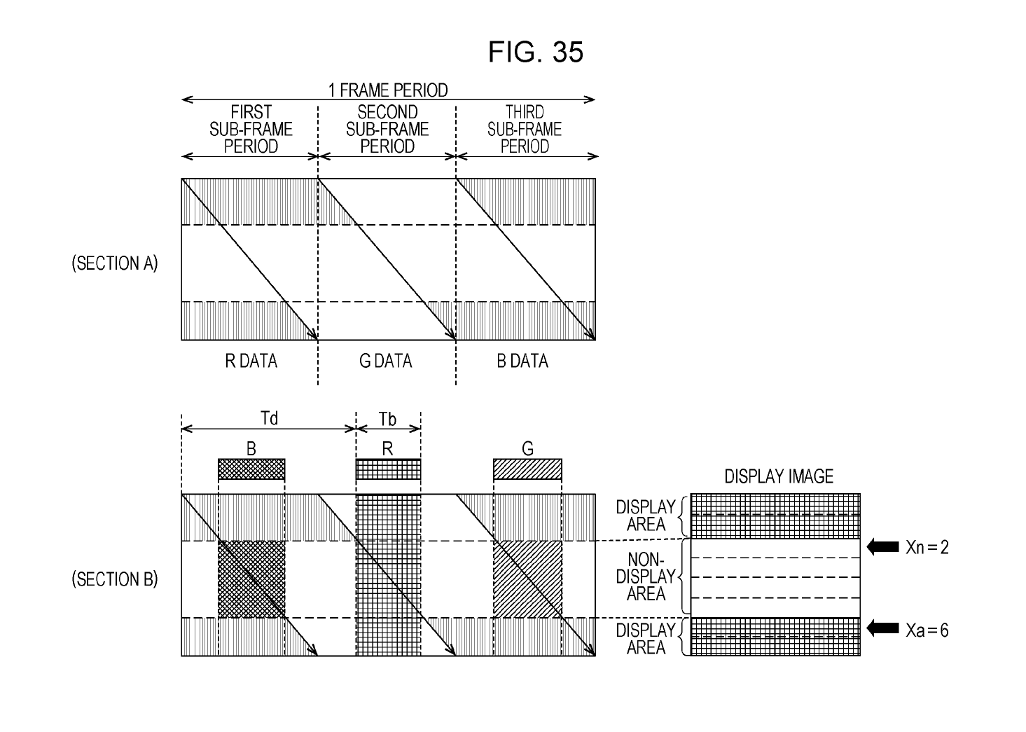

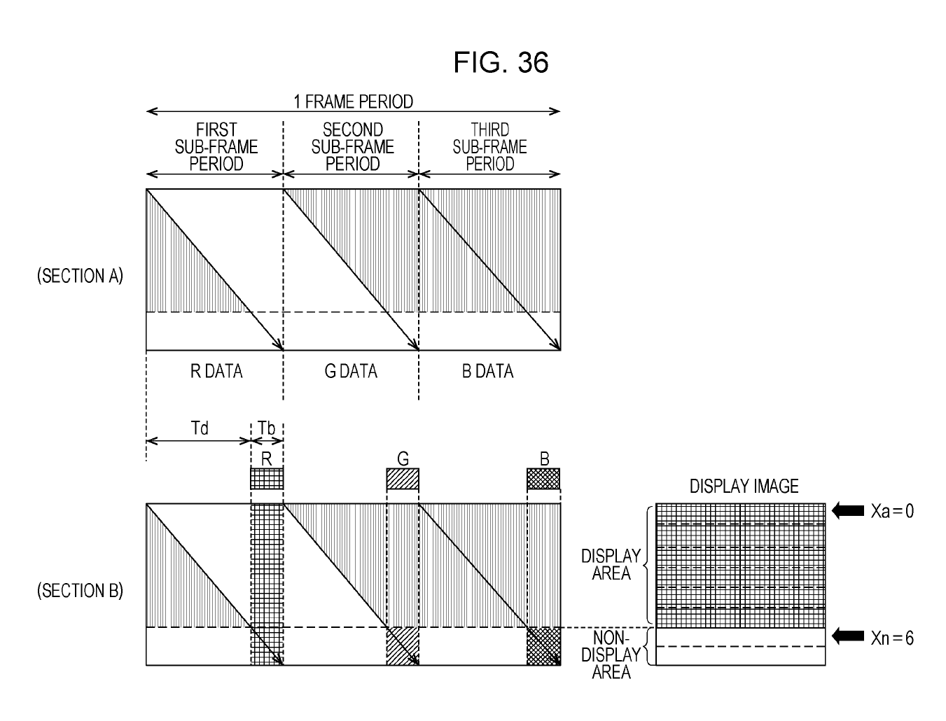

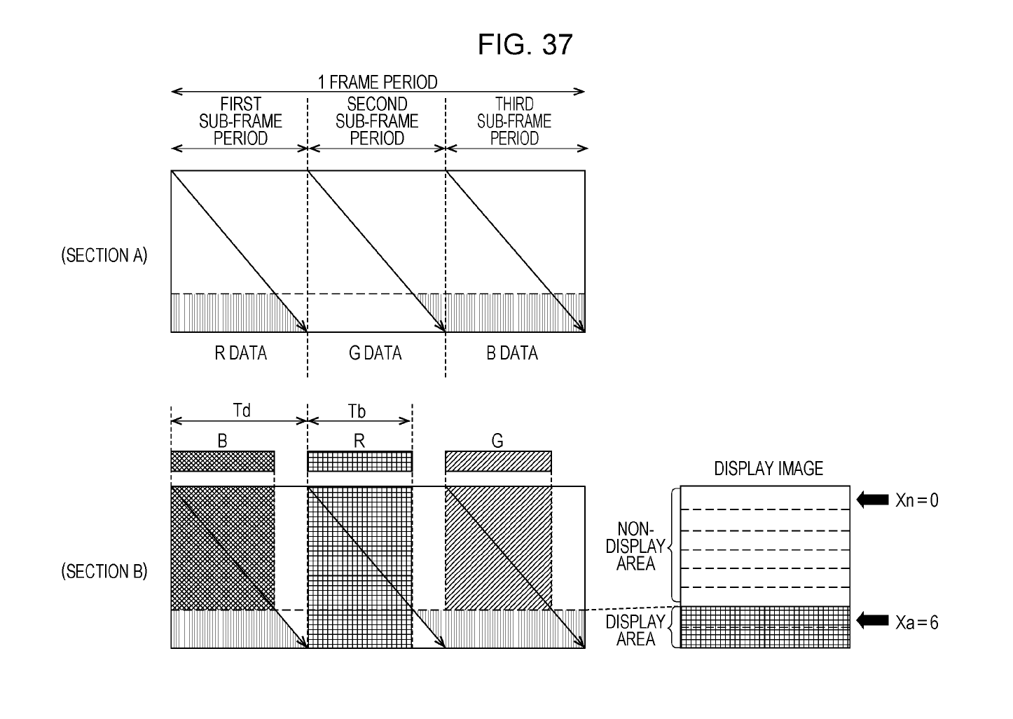

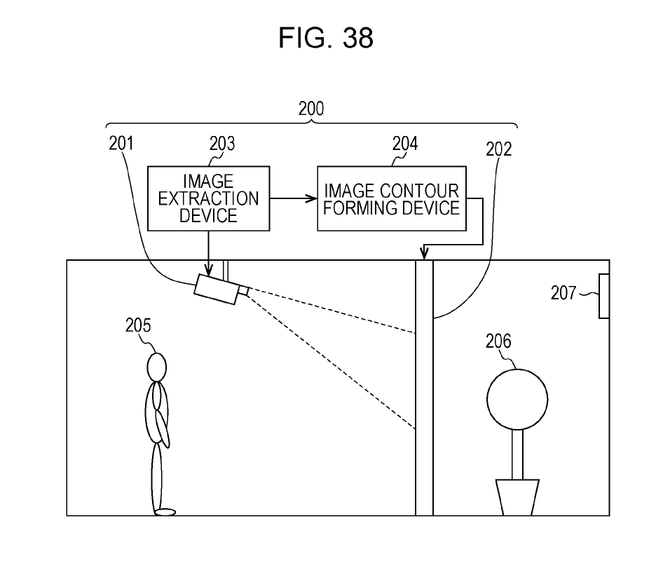

FIG. 34 is a diagram for describing an operation when a red image is displayed in the display area according to the embodiment. More specifically, Section A of FIG. 34 shows a timing at which red data is supplied to the CF-less liquid crystal panel 50 and Section B of FIG. 34 shows a light-up start time and a light-up time at which a light-emitting element of each color lights up. Here, the description will be made assuming that the liquid crystal response time Tl of the CF-less liquid crystal panel 50 is zero. In the description of a display image in Section B of FIG. 34 (the same applies to Section B of FIG. 35, Section B of FIG. 36, and Section B of FIG. 37), 1080 lines have to be described when the CF-less liquid crystal panel 50 is a liquid crystal panel including pixels of, for example, horizontal 1920×vertical 1080. However, for convenience, the description will be made below assuming that the CF-less liquid crystal panel 50 is configured to include a total of eight lines from a zeroth line at the upper most end and a seventh line at the lower most end. An area with a check pattern indicates a display area in which a red image is displayed and an area with no check pattern indicates a non-display area in a state in which a background color is transmitted at the maximum.

As shown Section B of FIG. 34, the display start line Xa is located at an upper line of the non-display start line Xn and the display start line Xa is not zero. Specifically, the display start line Xa is assumed to the second line and the non-display start line Xn is assumed to be the sixth line. In this case, the second to fifth lines become a display area and the zeroth, first, sixth, and seventh lines become non-display areas. Therefore, the display image data generation unit 141 generates the CF-less liquid crystal data CD including image data for realizing the display area and the non-display areas. In the embodiment, the number of pixels of the PDLC panel 60 is preferably plural, and the PDLC data PD generated by the white data generation unit 142 based on the display image position designation data Da, the display start line designation data Dal, and the non-display start line designation data Dn is preferably set such that the PDLC display elements 61 corresponding to the display area are in the diffusion state and the PDLC display elements 61 corresponding to the non-display areas are in the transmission state. In the embodiment, however, a mode in which the state of the entire PDLC panel 60 is set uniformly is not excluded.

The scanning driving starts from a start time of each of first to third sub-frame periods. For the first sub-frame period, the transmission data is supplied as the red data to the second to fifth lines through the scanning driving and the transmission data is also supplied as the red data to the zeroth and first lines and the sixth and seventh lines. For the second sub-frame period, the shielding data is supplied as the green data to the second to fifth lines and the transmission data is supplied as the green data to the zeroth and first lines and the sixth and seventh lines. For the third sub-frame period, the shielding data is supplied as the blue data to the second to fifth lines and the transmission data is supplied as the blue data to the zeroth and first lines and the sixth and seventh lines.

For each of the first to third sub-frame periods, the light-emitting elements of the corresponding color light up at a time delayed by the light-up driving adjustment time Td than the scanning driving start time of the corresponding color data and light off after the light source light-up time Tb has passed. Therefore, the red light-emitting elements 71r (82r) light up for the second half of the first sub-frame period to the first half of the second sub-frame period. The green light-emitting elements 71g (82g) light up for the second half of the second sub-frame period to the first half of the third sub-frame period. The blue light-emitting elements 71b (82b) light up for the second half of the third sub-frame period to the first half of the first sub-frame period of the subsequent frame period.

The red light is transmitted through the second to fifth lines to which the transmission data is supplied as the red data and is transmitted through the zeroth and first lines and the sixth and seventh lines to which the transmission data is supplied as the red data. However, the green light and the blue light are shielded so that a transmission amount is the minimum in the second to fifth lines and are transmitted through the zeroth and first lines and the sixth and seventh lines at the maximum. As a result, since only the red line is transmitted in the second to fifth lines, an image according to the red data is displayed. On the other hand, in the zeroth and first lines and the sixth and seventh lines, the light of each color is transmitted by the same amount of light, i.e., for the same time. Thus, the zeroth and first lines and the sixth and seventh lines become the non-display area through which the background color is transmitted at the maximum. In this way, the display area in which the red image is displayed is formed in the middle of the screen and the non-display areas in the state in which the background color is transmitted at the maximum are formed with the display area interposed between the upper and lower sides. When the number of pixels of the PDLC panel 60 is set to be one and the entire PDLC panel 60 is in the diffusion state at the time of the image display, white display is realized in the non-display areas.

In the embodiment, the light source light-up time and the driving timing control signal DT are controlled in correspondence to a period in which the color data necessary to display an image of a desired color is supplied to the display area. Therefore, the display area in which the image of the desired color and occurrence of the color irregularity is suppressed can be set at a desired position of the CF-less liquid crystal panel 50.

In the embodiment, the color data supplied to the non-display areas for each sub-frame period becomes the same data for each pixel of the non-display area. Therefore, the non-display area becomes an area in which occurrence of the color irregularity is suppressed. When the number of pixels of the PDLC panel 60 is set to be plural, for example, a background can be displayed in the non-display area.

Not only the configuration of the foregoing first embodiment but also the configuration of the first modification example of the foregoing first embodiment may be adopted as the configuration of the signal processing circuit 10 according to the embodiment. For the disposition of the CF-less liquid crystal panel 50 and the light radiation unit 90 in the embodiment, any of the foregoing first to third embodiments and the modification examples thereof may be adopted. In the embodiment, the frame interpolation process of the second modification example of the foregoing first embodiment may be performed.

### 4.6 First Modification Example

FIG. 35 is a diagram for describing an operation when a red image is displayed in display areas according to a first modification example of the foregoing fourth embodiment. More specifically, Section A of FIG. 35 shows a timing at which red data is supplied to the CF-less liquid crystal panel 50 and Section B of FIG. 35 shows a light-up start time and a light-up time at which a light-emitting element of each color lights up. As shown in Section B of FIG. 35, the display start line Xa is located at a lower line of the non-display start line Xn and the non-display start line Xn is not zero. Specifically, the display start line Xa is assumed to the sixth line and the non-display start line Xn is assumed to be the second line. In this case, the zeroth and first lines and the sixth and seventh lines become a display area and the second to fifth lines become non-display areas. Therefore, the display image data generation unit 141 generates the CF-less liquid crystal data CD including image data for realizing the display areas and the non-display area. The display image data generation unit 141 generates the image data displayed in the zeroth and first lines by delaying the image data by one sub-frame period.

The scanning driving starts from the start time of each of the first to third sub-frame periods. For the first sub-frame period, the transmission data is supplied as the red data to the second to fifth lines and the sixth and seventh lines through the scanning driving. For the second sub-frame period, the transmission data which is the red data to be supplied to the zeroth and first lines is supplied by delaying the transmission data by one sub-frame period. For the second sub-frame period, the transmission data is supplied as green data to the second to fifth lines and the shielding data is supplied as the green data to the sixth and seventh lines. For the third sub-frame period, the shielding data which is the green data to be supplied to the zeroth and first lines is supplied by delaying the shielding data by one sub-frame period. For the third sub-frame period, the transmission data is supplied as the blue data to the second to fifth lines and the shielding data is supplied as the blue data to the sixth and seventh lines. The shielding data which is the blue data to be supplied to the zeroth and first lines is supplied for the first sub-frame period of the subsequent frame period.

For each of the first to third sub-frame periods, the light-emitting elements of the corresponding color light up at a time delayed by the light-up driving adjustment time Td than the scanning driving start time of the corresponding color data and light off after the light source light-up time Tb has passed. Therefore, the red light-emitting elements 71r (82r) light up at a time delayed by the light-up driving adjustment time Td from the start time of the first sub-frame period. The green light-emitting elements 71g (82g) light up at a time delayed by the light-up driving adjustment time Td from the start time of the second sub-frame period. The blue light-emitting elements 71b (82b) light up at a time delayed by the light-up driving adjustment time Td from the start time of the third sub-frame period.

The red light is transmitted through the zeroth and first lines and the sixth and seventh lines to which the transmission data is supplied as the red data and is transmitted through the second to fifth lines to which the transmission data is supplied as the red data. However, the green light and the blue light are shielded so that a transmission amount is the minimum in the zeroth and first lines and the sixth and seventh lines and are transmitted through the second to fifth lines at the maximum. As a result, since only the red light is transmitted in the zeroth and first lines and the sixth and seventh lines, an image according to the red data is displayed. On the other hand, in the second to fifth lines, the light of each color is transmitted by the same amount of light, i.e., for the same time. Thus, the second to fifth lines become the non-display area through which the background color is transmitted at the maximum. In this way, the non-display area in the state in which the background color is transmitted at the maximum are formed in the middle of the screen and the display areas in which the red image is displayed are formed with the non-display area interposed between the upper and lower sides.

### 4.7 Second Modification Example

FIG. 36 is a diagram for describing an operation when a red image is displayed in a display area according to a second modification example of the fourth embodiment. More specifically, Section A of FIG. 36 shows a timing at which red data is supplied to the CF-less liquid crystal panel 50 and Section B of FIG. 36 shows a light-up start time and a light-up time at which a light-emitting element of each color lights up. As shown in Section B of FIG. 36, the display start line Xa is located at an upper line of the non-display start line Xn and the display start line Xa is zero. Specifically, the display start line Xa is assumed to the zeroth line and the non-display start line Xn is assumed to be the sixth line. In this case, the zeroth to fifth lines become a display area and the sixth and seventh lines become non-display area. Therefore, the display image data generation unit 141 generates the CF-less liquid crystal data CD including image data for realizing the display area and the non-display area.

The scanning driving starts from the start time of each of the first to third sub-frame periods. For the first sub-frame period, the transmission data is supplied as the red data to the zeroth to fifth lines and the sixth and seventh lines through the scanning driving. For the second sub-frame period, the shielding data is supplied as the green data to the zeroth to fifth lines and the transmission data is supplied as the green data to the sixth and seventh lines. For the third sub-frame period, the shielding data is supplied as the blue data to the zeroth to fifth lines and the transmission data is supplied as the blue data to the sixth and seventh lines.

For each of the first to third sub-frame periods, the light-emitting elements of the corresponding color light up at a time delayed by the light-up driving adjustment time Td than the scanning driving start time of the corresponding color data and light off after the light source light-up time Tb has passed. Therefore, the red light-emitting elements 71r (82r) light up from the second half of the first sub-frame period to the end time thereof. The green light-emitting elements 71g (82g) light up from the second half of the second sub-frame period to the end time thereof. The blue light-emitting elements 71b (82b) light up from the second half of the third sub-frame period to the end time thereof.

The red light is transmitted through the zeroth to fifth lines to which the transmission data is supplied as the red data and is transmitted through the sixth and seventh lines to which the transmission data is supplied as the red data. However, the green light and the blue light are shielded so that a transmission amount is the minimum in the zeroth to fifth lines and are transmitted through the sixth and seventh lines at the maximum. As a result, since only the red line is transmitted in the zeroth to fifth lines, an image according to the red data is displayed. On the other hand, in the sixth and seventh lines, the light of each color is transmitted by the same amount of light, i.e., for the same time. Thus, the sixth and seventh lines become the non-display areas through which the background color is transmitted at the maximum. In this way, the display area in which the red image is displayed is formed in the upper portion of the screen and the non-display area in the state in which the background color is transmitted at the maximum is formed in the lower portion of the screen.

### 4.8 Third Modification Example

FIG. 37 is a diagram for describing an operation when a red image is displayed in a display area according to a third modification example of the foregoing fourth embodiment. More specifically, Section A of FIG. 37 shows a timing at which red data is supplied to the CF-less liquid crystal panel 50 and Section B of FIG. 37 shows a light-up start time and a light-up time at which the light-emitting element of each color lights up. As shown in Section B of FIG. 37, the display start line Xa is located at a lower line of the non-display start line Xn and the non-display start line Xn is zero. Specifically, the display start line Xa is assumed to the sixth line and the non-display start line Xn is assumed to be the zeroth line. In this case, the zeroth to fifth lines become a non-display area and the sixth and seventh lines become a display area. Therefore, the display image data generation unit 141 generates the CF-less liquid crystal data CD including image data for realizing the display area and the non-display area.

The scanning driving starts from the start time of each of the first to third sub-frame periods. For the first sub-frame period, the transmission data is supplied as the red data to the zeroth to fifth lines and the sixth and seventh lines through the scanning driving. For the second sub-frame period, the transmission data is supplied as the green data to the zeroth to fifth lines and the shielding data is supplied as the green data to the sixth and seventh lines. For the third sub-frame period, the transmission data is supplied as the blue data to the zeroth to fifth lines and the shielding data is supplied as the blue data to the sixth and seventh lines.

For each of the first to third sub-frame periods, the light-emitting elements of the corresponding color light up at a time delayed by the light-up driving adjustment time Td than the scanning driving start time of the corresponding color data and light off after the light source light-up time Tb has passed. Therefore, the red light-emitting elements 71r (82r) light up from the start time of the second sub-frame period and light off before the end time thereof. The green light-emitting elements 71g (82g) light up from the start time of the third sub-frame period and light off before the end time thereof. The blue light-emitting elements 71b (82b) light up from the start time of the first sub-frame period of the subsequent frame period and light off before the end time thereof.

The red light is transmitted through the zeroth to fifth lines to which the transmission data is supplied as the red data and is transmitted through the sixth and seventh lines to which the transmission data is supplied as the red data. However, the green light and the blue light are shielded so that a transmission amount is the minimum in the sixth and seventh lines and are transmitted through the zeroth to fifth lines at the maximum. As a result, since only the red light is transmitted in the sixth and seventh lines, an image according to the red data is displayed. On the other hand, in the zeroth to fifth lines, the light of each color is transmitted by the same amount of light, i.e., for the same time. Thus, the zeroth to fifth lines become the non-display areas through which the background color is transmitted at the maximum. In this way, the non-display area in the state in which the background color is transmitted at the maximum is formed in the upper portion of the screen and the display area in which the red image is displayed is formed in the lower portion of the screen.

### 5. Others

The invention is not limited to the above-described embodiments, but can be modified in various ways within the scope of the invention without departing from the gist of the invention. For example, any of other display apparatuses capable of switching transmission display and shielding display may be used instead of the CF-less liquid crystal panel 50. Examples of the other display apparatuses capable of switching transmission display and shielding display include a display apparatus using an electrowetting principle, a display apparatus using an electrochromic compound, a display apparatus using electrophoretic bodies, a display apparatus using a digital micromirror device (DMD), and a display apparatus using a microshutter. In the other display apparatuses capable of switching transmission display and shielding display other than the CF-less liquid crystal panel 50, the “shielding display” includes a case in which light is diffused only on the side of a light source (the side of a light guide plate when the light guide plate is used).

Any of other display apparatuses capable of switching transmission display and diffusion display may be used instead of the PDLC panel 60. Examples of the other display apparatuses capable of switching transmission display and diffusion display include a display apparatus using an electrowetting principle, a display apparatus using an electrochromic compound, a display apparatus using electrophoretic bodies, a display apparatus using a digital micromirror device (DMD), and a display apparatus using a microshutter. In the other display apparatuses capable of switching transmission display and diffusion display other than the PDLC panel 60, the “diffusion display” includes a case in which light is diffused only on a side at which radiated light (also including background light) arrives. A display apparatus capable of switching transmission display and diffusion display of light with color (including a case in which light is diffused on a side at which radiated light (also including a background light, as described above) arrives) may be used instead of the PDLC panel 60. In this case, the light source unit 100 may not be necessarily be configured to emit light of a plurality of colors and may be configured to emit white light. Even in this case, the entire light radiation unit 90 can radiate the light of the plurality of colors to the CF-less liquid crystal panel 50.

In the foregoing first embodiment and the first modification example thereof, the CF-less liquid crystal timing designation signal CT, the PDLC timing designation signal PT, and the light source timing designation signal LT generated by the timing designation control unit 15 based on the driving timing control signal DT has been supplied to each of the CF-less liquid crystal display element signal control unit 16, the PDLC display element signal control unit 17, and the light source signal control unit 18 in the above description, but the invention is not limited thereto. The timing designation control unit 15 may not be provided and the image control unit 14 may be configured to supply the driving timing control signal DT to the CF-less liquid crystal display element signal control unit 16, the PDLC display element signal control unit 17, and the light source signal control unit 18.

In the first and third embodiments and each modification example thereof, a mechanism (for example, a box for which each panel or the like is disposed on its front and rear surfaces and in which the exhibition object 110 is disposed inside) diffusing the light-source light may be adopted to improve the use efficiency of the light-source light of the first and second PDLC light source units 70a and 70b.

In the foregoing second and third embodiments, the area active-driving has been performed using the light guide plate formed by the blocks in the above description, but the invention is not limited thereto. The area active-driving may be performed using a normal light guide plate not configured by blocks as in FIG. 17. In this case, a light guide plate in which the source light of the front surface emitted light is small and transmittance is high is preferably used to see through a background more clearly when a spot in which the image display is not performed is in a transmission state.

In the foregoing third embodiment and each modification example thereof, as in the third modification example of the foregoing first embodiment, the first PDLC light source unit 70a may radiate the light-source light to the front surface of the PDLC panel 60. In the foregoing third embodiment and each modification example thereof, as in the fourth modification example of the foregoing first embodiment, the light-source light may be radiated to the front and rear surfaces of the PDLC panel 60 using the first and second PDLC light source units 70a and 70b. Thus, it is possible to further improve the luminance of the display image.

### REFERENCE SIGNS LIST

1 IMAGE DISPLAY DEVICE
10 SIGNAL PROCESSING CIRCUIT (SIGNAL PROCESSING UNIT)
11 SIGNAL SEPARATION CONTROL UNIT
12 FS PROCESSING UNIT
13 MEMORY
14 IMAGE CONTROL UNIT
15 TIMING DESIGNATION CONTROL UNIT
16 CF-LESS LIQUID CRYSTAL DISPLAY ELEMENT SIGNAL CONTROL UNIT (FIRST DISPLAY CONTROL UNIT)
17 PDLC DISPLAY ELEMENT SIGNAL CONTROL UNIT (SECOND DISPLAY CONTROL UNIT)
18 LIGHT SOURCE SIGNAL CONTROL UNIT (LIGHT SOURCE CONTROL UNIT)
20 CF-LESS LIQUID CRYSTAL DISPLAY ELEMENT DRIVING CIRCUIT (FIRST DISPLAY DRIVING UNIT)
30 PDLC DISPLAY ELEMENT DRIVING CIRCUIT (SECOND DISPLAY DRIVING UNIT)
40 LIGHT SOURCE DRIVING CIRCUIT (LIGHT SOURCE DRIVING UNIT)
50 CF-LESS LIQUID CRYSTAL PANEL (FIRST DISPLAY PANEL)
51 CF-LESS LIQUID CRYSTAL DISPLAY ELEMENT (FIRST DISPLAY ELEMENT)
60 PDLC PANEL (SECOND DISPLAY PANEL)
61 PDLC DISPLAY ELEMENT (SECOND DISPLAY ELEMENT)
71, 82 LIGHT SOURCE
71r, 71g, 71b RED, GREEN, AND BLUE LIGHT-EMITTING ELEMENTS
82r, 82g, 82b RED, GREEN, AND BLUE LIGHT-EMITTING ELEMENTS
80 BACKLIGHT UNIT
81 LIGHT SOURCE UNIT FOR LIGHT GUIDE PLATE
83a, 83b FIRST AND SECOND LIGHT GUIDE PLATES
90 LIGHT RADIATION UNIT
100 LIGHT SOURCE UNIT
IN INPUT SIGNAL
ID IMAGE DATA
FID FIELD SEQUENTIAL IMAGE DATA
Da DISPLAY IMAGE POSITION DESIGNATION DATA
Dal DISPLAY START LINE DESIGNATION DATA
Dn NON-DISPLAY START LINE DESIGNATION DATA
Din RESPONSE TIME DATA
CD CF-LESS LIQUID CRYSTAL DATA (FIRST DISPLAY DATA)
PD PDLC DATA (SECOND DISPLAY DATA)
LD LIGHT SOURCE DATA
DT DRIVING TIMING CONTROL SIGNAL

1. An image display device that displays an image by dividing one frame period of a supplied input signal into a plurality of sub-frame periods and switching a display color for each sub-frame period, the image display device comprising:
a first display panel that includes a plurality of first display elements disposed in a matrix form; and
a light radiation unit that is able to radiate light of a plurality of colors to the first display panel, wherein
the light radiation unit includes
a light source unit, and
a second display panel which is able to switch between a diffusion state in which incident light is diffused and a transmission state in which incident light is transmitted,
the second display panel is in the diffusion state and diffuses light emitted by the light source unit when the image is displayed, and
the first display panel displays the image by controlling transmittance of the light diffused by the second display panel.

2. The image display device according to claim 1, wherein the light source unit further includes a first light source unit for the second display panel, the first light source unit including light-emitting elements of the plurality of colors and radiating light to the second display panel.

3. The image display device according to claim 2, wherein the first light source unit for the second display panel radiates light to one main surface of the second display panel.

4. The image display device according to claim 3, wherein
the light source unit further includes a second light source unit for the second display panel, the second light source unit including light-emitting elements of the plurality of colors and radiating light to the second display panel, and
the first light source unit for the second display panel and the second light source unit for the second display panel radiate light to both main surfaces of the second display panel, respectively.

5. The image display device according to claim 2, wherein the first light source unit for the second display panel has enough directivity to radiate light to a part of the second display panel.

6. The image display device according to claim 1, wherein
the light radiation unit further includes a first light guide plate guiding incident light, and
the light source unit includes a light source unit for a light guide plate including light-emitting elements of the plurality of colors and radiating light to the first light guide plate.

7. The image display device according to claim 6, wherein the first light guide plate and the second display panel are disposed in order on a side of the first display panel.

8. The image display device according to claim 6, wherein the second display panel and the first light guide plate are disposed in order on a side of the first display panel.

9. The image display device according to claim 6, wherein
the light radiation unit further includes a second light guide plate guiding incident light,
the light source unit for the light guide plate radiates light to the first light guide plate and the second light guide plate, and
the first light guide plate, the second display panel, and the second light guide plate are disposed in order on a side of the first display panel.

10. The image display device according to claim 6, wherein
the first light guide plate is configured to be formed by a plurality of blocks, and
the light source unit for the light guide plate radiates light to each block.

11. The image display device according to claim 1, wherein the second display panel includes a plurality of second display elements each of which is switchable between the diffusion state and the transmission state.

12. The image display device according to claim 11, wherein when the image is displayed, each of the second display elements in correspondence to one of the plurality of first display elements is in the diffusion state in synchronization with the corresponding first display element.

13. The image display device according to claim 1, further comprising:
a first display driving unit that drives the first display panel;
a second display driving unit that drives the second display panel;
a light source driving unit that drives the light source unit; and
a signal processing unit that controls each of the first display driving unit, the second display driving unit, and the light source driving unit based on the input signal.

14. The image display device according to claim 13, wherein the signal processing unit includes
a field sequential processing unit that generates field sequential image data for displaying an image for each sub-frame period based on the input signal,
an image control unit that generates first display data for controlling the first display driving unit, second display data for controlling the second display driving unit, and light source data for controlling the light source driving unit, based on display image position designation data for designating a display position of the image to be displayed and the field sequential image data, which are obtained based on the input signal,
a first display control unit that controls the first display driving unit based on the first display data,
a second display control unit that controls the second display driving unit based on the second display data, and
a light source control unit that controls the light source driving unit based on the light source data.

15. The image display device according to claim 14, wherein
the input signal includes the display image position designation data and image data indicating the image to be displayed, and
the signal processing unit further includes a signal separation control unit that separates the input signal into the display image position designation data and the image data and supplies the display image position designation data and the image data to the image control unit and the field sequential processing unit, respectively.

16. The image display device according to claim 14, wherein the field sequential processing unit further generates the display image position designation data based on the input signal.

17. The image display device according to claim 13, wherein the signal processing unit interpolates an image to be displayed for each of continuous frame periods using the sub-frame period.

18. The image display device according to claim 13, wherein
the first display panel includes a display area for displaying the image of a desired color when color data is supplied for each sub-frame period, and
the signal processing unit generates the color data based on the input signal for each sub-frame period, obtains a light source light-up time designating a light-up time of the light-emitting element of a color indicated by the color data and a light source driving timing control signal for controlling at least one of a light-up start time of the light-emitting element of the color and a scanning start time at which the color data is supplied to the display area, and controls the light source light-up time and the light source driving timing control signal in correspondence to a period in which the color data necessary to display the image of the desired color is supplied to the display area.

19. The image display device according to claim 18, wherein
the first display panel includes a non-display area in which color data is supplied for each sub-frame period and the image is not displayed, and
the color data supplied to the non-display area is same color data for each pixel of the non-display area.

20. The image display device according to claim 19, wherein the signal processing unit further includes
a field sequential processing unit that generates field sequential image data for displaying an image for each sub-frame period based on the input signal,
an image control unit that generates first display data for controlling the first display driving unit, second display data for controlling the second display driving unit, and light source data for controlling the light source driving unit and including the light-source light-up time, based on display image position designation data for designating a display position of the image to be displayed and the field sequential image data, which are obtained based on the input signal,
a first display control unit that controls the first display driving unit based on the first display data,
a second display control unit that controls the second display driving unit based on the second display data, and
a light source control unit that controls the light source driving unit based on the light source driving timing control signal and the light source data.

21. A driving method for an image display device that includes a first display panel including a plurality of first display elements disposed in a matrix form and a light radiation unit able to radiate light of a plurality of colors to the first display panel and including a second display panel, and that displays an image by dividing one frame period of a supplied input signal into a plurality of sub-frame periods and switching a display color for each sub-frame period, the driving method comprising:
a step of switching a state of the second display panel between a diffusion state in which incident light is diffused and a transmission state in which incident light is transmitted; and
a step of causing the first display panel to control transmittance of light diffused by the second display panel and to display the image, wherein
the light radiation unit further includes a light source unit, and
the step of switching the state of the second display panel includes a step of switching the state of the second display panel to the diffusion state when the image is displayed and diffusing light emitted by the light source unit.
